(19) United States
(12) Patent Application Publication
(10) Pub. No.: US 2026/0217297 A1
(43) Pub. Date: Jul. 30, 2026

(54) WHEEL STEERING MECHANISM AND STROLLER

(71) Applicant: WONDERLAND SWITZERLAND AG, Steinhausen (CH)

(72) Inventor: Jialiang YUAN, Dongguan (CN)

(21) Appl. No.: 19/147,978

(22) PCT Filed: Jan. 12, 2024
(86) PCT No.: PCT/EP2024/050690

§ 371 Date: Jul. 14, 2025

(30) Foreign Application Priority Data
Jan. 16, 2023 (CN) 202310078532.6

(51) Int. Cl. B62B 7/04; B62B 7/06

(52) U.S. Cl. CPC B62B 7/042; B62B 7/064

(57) ABSTRACT

The disclosure relates to a wheel steering mechanism for steering a wheel mechanisms of a stroller, the wheel steering mechanism has: a linkage member for steering a pair of wheel mechanisms of the stroller in linkage; a crossbar for connecting two wheel seats of the stroller, the wheel seats being respectively pivotally connected to the wheel mechanisms; a holding device, arranged between the linkage member and the crossbar and used for holding the pair of wheel mechanisms to be steered in linkage. The disclosure further relates to a stroller including the wheel steering mechanism.

This application is a National Stage application of PCT/EP2024/050690, entitled “WHEEL STEERING MECHANISM AND STROLLER” and filed on Jan. 12, 2024, which claims the benefit of Chinese Application No. 202310078532.6, filed on Jan. 16, 2023, both of which are incorporated herein by reference in their entirety.

### TECHNICAL FIELD

The present disclosure relates to the field of strollers, and more particularly, to a wheel steering mechanism for realizing a wheel drift function of the strollers and its unlock holding assembly.

### BACKGROUND

At present, there are strollers with drift function on the market, in which each front wheel and each rear wheel can rotate in all directions around a roughly vertical axis, thus allowing the stroller to travel in any direction. Strollers with drift function are rare in the market, and even if there are some, they are small strollers, and they are usually two-wheeled. If the wheels are small and only a single wheel has the drift function, the stroller would be to overturn during use, and the stability is not so good. When such mechanism is applied to a child stroller, it brings potential safety hazards.

For this, it is necessary to provide a steering mechanism suitable for larger wheels, which can provide a dual-wheel drift function while providing better stability

### SUMMARY

According to the disclosure, a wheel steering mechanism is provided for steering a wheel mechanism of a stroller, the wheel steering mechanism has: a linkage member for steering a pair of wheel mechanisms of the stroller in linkage; a crossbar for connecting two wheel seats of the stroller, the wheel seats being respectively pivotally connected to the wheel mechanisms; and a holding device, arranged between the linkage member and the crossbar and used for holding the pair of wheel mechanisms to be steered in linkage.

According to an embodiment, the holding device has a locking member for locking the wheel mechanisms in a forward direction, and the locking member enables, after being unlocked, the wheel mechanisms to be steered in linkage.

According to an embodiment, the holding device has a guide rail for holding and guiding the locking member.

According to an embodiment, the holding device has a blocking member, and the blocking member is arranged between the linkage member and the crossbar.

According to an embodiment, when the wheel mechanisms are in the forward direction, the locking member is capable of being inserted into the blocking member to lock the wheel mechanisms in the forward direction.

According to an embodiment, the blocking member has a locking slot, and the locking member is capable of being inserted into the locking slot.

According to an embodiment, the wheel steering mechanism has a release member for unlocking the locking member from the blocking member, such that the wheel mechanisms are capable of being steered in linkage.

According to an embodiment, the release member unlocks the locking member and the blocking member through a dragging member.

According to an embodiment, the release member is arranged in an accommodating mechanism, and the accommodating mechanism is fastened on a lower side of a cover body covering the wheel steering mechanism.

According to an embodiment, the blocking member is connected to the accommodating mechanism or the cover body through a tension spring, such that when the wheel mechanisms returns to the forward direction, the blocking member is capable of moving away from the crossbar along with the linkage member.

According to an embodiment, the release member is arranged in an accommodating mechanism, and the accommodating mechanism is fastened on a handlebar of the stroller.

According to an embodiment, the blocking member is connected to a fixing portion arranged on a lower side of a cover body of the wheel steering mechanism through a tension spring, such that when the wheel mechanisms returns to the forward direction, the blocking member is capable of moving away from the crossbar along with the linkage member.

According to an embodiment, the blocking member has a first long slot, the crossbar has a penetrating hole, and a first guide post penetrates the first long slot and the penetrating hole, such that the blocking member is capable moving in respect to the crossbar.

According to an embodiment, the blocking member has a U-shaped guide portion connected to the crossbar, and the U-shaped guide portion has two first long slots parallel to a stretching direction of the tension spring.

According to an embodiment, the holding device has a protective cover for covering the blocking member, the protective cover has a first protective cover hole, and the first guide post is inserted into the first protective cover hole.

According to an embodiment, on a side of the linkage member opposite to the crossbar, the protective cover has a second protective cover hole, and the second protective cover hole and a second long slot of the blocking member are used for receiving a second guide post.

According to an embodiment, a guide rail is arranged on the protective cover, and the locking member is operatively arranged on the guide rail to achieve locking or unlocking to the blocking member.

According to an embodiment, the release member has a dragging portion, and the dragging member is dragged in a chute of the dragging portion due to a movement of the dragging portion, such that the locking member unlocks the blocking member.

According to an embodiment, the accommodating mechanism has: a bottom cover and a lower cover for enclosing an accommodation space, the accommodation space being used for accommodating the release member; and a positioning member, located in the accommodation space, and used for positioning the release member at different positions to move the dragging portion.

According to an embodiment, the accommodating mechanism has: a compression spring, supported between a button of the release member and a bottom of the accommodating mechanism; and a fixing member for fixing the positioning member and supporting the compression spring at an end on the bottom of the accommodating mechanism, wherein by the compression spring, the other end of the positioning member is capable of being positioned in a plurality of grooves of the release member.

According to an embodiment, the wheel mechanisms has fixing seats pivotally connected to the wheel seats through connecting portions, and the connecting portions are pivotally connected to the linkage member in turn, such that the pair of wheel mechanisms move synchronously while being steered.

According to an embodiment, a leftward or rightward steerable angle range of the wheel mechanisms is from 30° to 40°.

According to an embodiment, the wheel steering mechanism is a rear wheel steering mechanism.

According to the disclosure, a stroller is provided, and the stroller comprises the wheel steering mechanism according to the disclosure.

### BRIEF DESCRIPTION OF THE DRAWINGS

FIG. 1 shows a perspective view of a stroller according to a first embodiment of the disclosure, in which rear wheels are in a forward direction;

FIG. 2 shows a perspective view of the stroller according to the first embodiment of the disclosure, in which the rear wheels are steered in drifting leftward;

FIG. 3 shows a perspective view of the stroller according to the first embodiment of the disclosure, in which the rear wheels are steered in drifting rightward;

FIG. 4 shows a bottom view of a rear wheel steering mechanism of the stroller according to the first embodiment of the disclosure;

FIG. 5 shows a top view of the rear wheel steering mechanism of the stroller according to the first embodiment of the disclosure, in which the rear wheels are in the forward direction;

FIG. 6 shows a top view of the rear wheel steering mechanism of the stroller according to the first embodiment of the disclosure, in which the rear wheels are steered in drifting leftward;

FIG. 7 shows a perspective view of the rear wheel steering mechanism of the stroller according to the first embodiment of the disclosure, in which a holding device, an accommodating mechanism, and a release member are cut open;

FIG. 8 is an enlarged view of the holding device, the accommodating mechanism, and the release member which are shown cut open in FIG. 7;

FIG. 9 shows a rear view of the rear wheel steering mechanism of the stroller according to the first embodiment of the disclosure, in which the holding device is cut open and the locking member is in an inserted state;

FIG. 10 shows a rear view of the rear wheel steering mechanism of the stroller according to the first embodiment of the disclosure, in which the holding device is cut open and the locking member is in a pulled-out state;

FIG. 11 shows a perspective view of the rear wheel steering mechanism of the stroller according to the first embodiment of the disclosure, in which the holding device is provided with a protective cover;

FIG. 12 shows a perspective view of the rear wheel steering mechanism of the stroller according to the first embodiment of the disclosure, in which the holding device is provided without the protective cover;

FIG. 13 shows a perspective view of the rear wheel steering mechanism of the stroller according to the first embodiment of the disclosure from an opposite side of FIG. 11, in which the holding device is provided with the protective cover;

FIG. 14 shows a perspective view of the rear wheel steering mechanism of the stroller in FIG. 13, and the holding device, the accommodating mechanism, and the release member are shown in an exploded view;

FIG. 15 shows an enlarged exploded view of the holding device, the accommodating mechanism, and the release member in FIG. 14;

FIG. 16 shows a perspective view of a wheel mechanism according to the first embodiment of the disclosure at the rear wheels of the stroller, in which the rear wheels are in the forward direction;

FIG. 17 shows a perspective view of the wheel mechanism according to the first embodiment of the disclosure at the rear wheels of the stroller, in which the rear wheels are steered in drifting leftward;

FIG. 18 shows a top view of the rear wheel steering mechanism of the stroller according to the first embodiment of the disclosure, in which the rear wheels are in the forward direction;

FIG. 19 shows a top view of the rear wheel steering mechanism of the stroller according to the first embodiment of the disclosure, in which the rear wheels are steered in drifting leftward;

FIG. 20 shows a perspective view of the rear wheel steering mechanism of the stroller according to the first embodiment of the disclosure, in which only a holding device without protective cover is provided, the rear wheels are in the forward direction, and the locking member insert into a blocking member;

FIG. 21 shows a rear view of the rear wheel steering mechanism of the stroller in FIG. 20, in which an accommodating mechanism and a release member are provided, and the release member is in a locked state at this time;

FIG. 22 shows an enlarged view of the accommodating mechanism and the release member in FIG. 21, and the release member is in a locked state at this time;

FIG. 23 shows a perspective view of the rear wheel steering mechanism of the stroller according to the first embodiment of the disclosure, in which only a holding device having no cover is provided, the rear wheels are steered to the left and drifting, and the locking member is pulled out from the blocking member;

FIG. 24 shows a rear view of the rear wheel steering mechanism of the stroller in FIG. 23, in which an accommodating mechanism and a release member are provided;

FIG. 25 shows an enlarged view of the accommodating mechanism and the release member in FIG. 24, in which the release member is in an unlocked state at this time;

FIG. 26 shows a perspective view of the stroller according to a second embodiment of the disclosure, in which the rear wheels are in the forward direction;

FIG. 27 shows a perspective view of the rear wheel steering mechanism of the stroller according to the second embodiment of the disclosure, in which the holding device is provided with a protective cover;

FIG. 28 shows a perspective view of the rear wheel steering mechanism of the stroller according to the second embodiment of the disclosure, in which the holding device is provided without the protective cover;

FIG. 29 shows a perspective view of the rear wheel steering mechanism of the stroller according to FIG. 28, in which no accommodating mechanism is provided, and the release member is in a locked state at this time;

FIG. 30 shows an enlarged view of the holding device and the release member in FIG. 29, in which the release member is in a locked state at this time;

FIG. 31 shows a perspective view of the rear wheel steering mechanism of the stroller, in which no accommodating mechanism is provided, and the release member is in a unlocked state at this time;

FIG. 32 shows an enlarged view of the holding device and the release member in FIG. 31, and the release member is in an unlocked state at this time;

FIG. 33 shows a front perspective view of a stroller according to a third embodiment of the disclosure;

FIG. 34 shows a rear perspective view of the stroller according to the third embodiment of the disclosure;

FIG. 35 shows an underside perspective view of the stroller according to the third embodiment of the disclosure;

FIG. 36 shows a rear perspective view of the stroller according to FIG. 34, in which no cover body is provided;

FIG. 37 shows a rear perspective view of the stroller according to FIG. 36, in which the holding device is provided without the protective cover, and the locking member is in an inserted state;

FIG. 38 shows a rear perspective view of the stroller corresponding to FIG. 37, without the protective cover of the holding device, and the locking member is in a pulled-out state;

FIG. 39 shows a handlebar according to the third embodiment of the disclosure, in which the release member is in a locked state;

FIG. 40 shows the handlebar according to the third embodiment of the disclosure, in which the release member is in unlocked state;

FIG. 41 shows the handlebar according to the third embodiment of the disclosure, in which the release member has a holding function.

### DETAILED DESCRIPTION

Although the invention is illustrated and described herein with reference to specific embodiments, it should not be limited to the details shown. Rather, various modifications may be made to these details within the scope of equivalents of the claims without departing from the invention.

Directional descriptions such as “front,” “back,” “upper,” and “lower” related in the specification are only used for convenience of understanding, and the invention is not limited to these directions, but can be adjusted according to the actual situation. Furthermore, although the application has been described with reference to typical embodiments, the terminology used is illustrative and exemplary, not restrictive.

Since this application can be embodied in various forms without departing from the spirit and essence of this application, it should be understood that the above-mentioned embodiments are not limited to any of the foregoing details, but should be interpreted as broadly as possible within the scope defined by the claims, and therefore all changes that fall within the scope of the claims or their equivalents should be covered by the claims.

A basic structural principle of the disclosure is that if a button of a release member is operated, a dragging member will bring a locking member to be unlocked, and rear wheels will be held in a driftable state.

A technical problem solved by the disclosure is to provide a stroller, especially a stroller with large rear wheels, particularly a baby stroller, and drifting of the rear wheels can be controlled within a certain range to prevent the stroller from being unstable. In the disclosure, the first embodiment, the second embodiment and the third embodiment can have a drift holding function. The embodiments are simple in structure and convenient in operation.

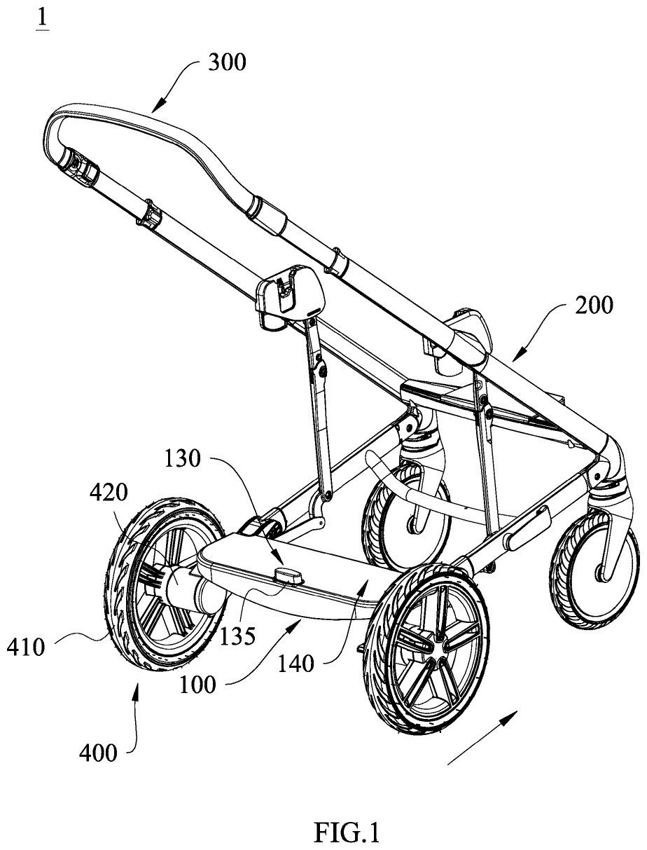

Hereinafter, the disclosure will be described in detail with reference to the attached drawings, in which FIGS. 1 to 25 show the structure of a stroller 1 according to the first embodiment of the disclosure.

FIG. 1 shows a perspective view of the stroller 1 according to the first embodiment of the disclosure, in which rear wheels 410 are in a forward direction. In such case, the rear wheels 410 may be in a drift locked state or a driftable state.

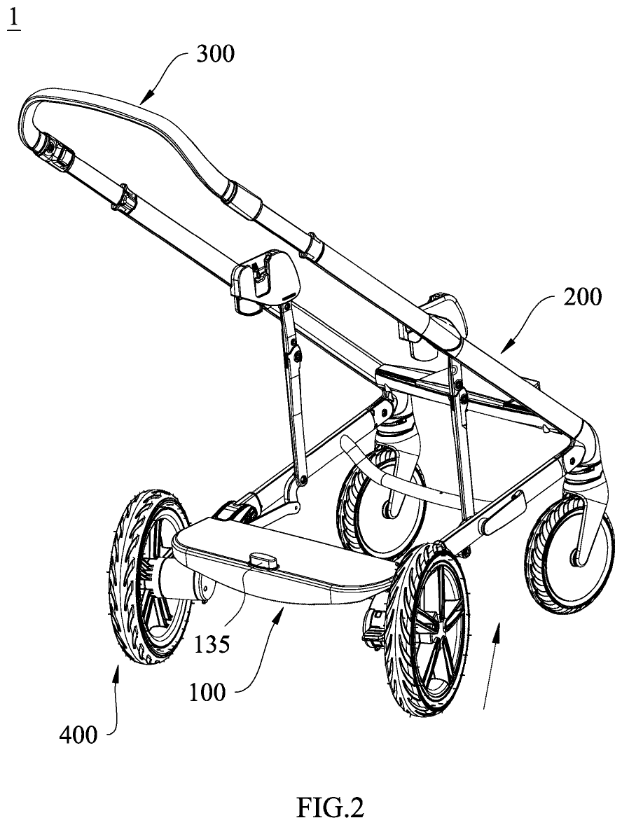

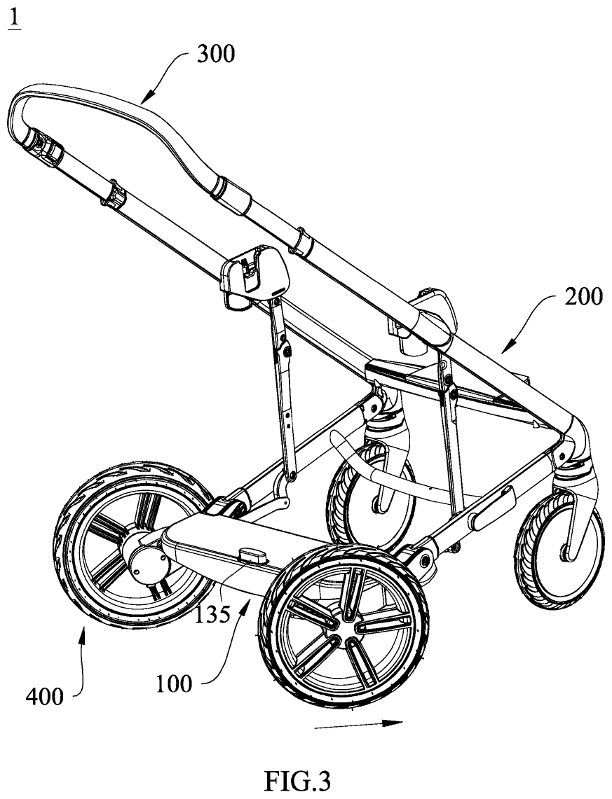

In this embodiment, the stroller 1 can be especially a baby stroller 1 having a frame 200, a handlebar 300, four wheel mechanisms 400, and a wheel steering mechanism 100. The frame 200 is, for example, assembled from a plurality of preferably hollow rods by means of couplings, such that folding of the baby stroller 1 can be realized, for example. The handlebar 300 is assembled from preferably hollow rods likely, and is connected, especially plugged, to an upper portion of the frame 200 for pushing the baby stroller 1. In this embodiment, four wheel mechanisms 400 are symmetrically arranged in pairs on a lower side of the frame 200, two wheel mechanisms 400 at the front of the baby stroller 1 are used for the front wheels 410 of the stroller, and two wheel mechanisms 400 at the rear of the baby stroller 1 are used for the rear wheels 410 of the stroller. According to this embodiment, the rear wheels 410 can be especially larger than the front wheels 410, each of the wheel mechanisms 400 for the rear wheels 410 includes a wheel 410 and a fixing seat 420, and the fixing seat 420 is pivotally connected to the wheel 410 and pivotally coupled to a lower rear portion of the frame 200. The rear wheels 410 is pivotally connected to the frame 200 through the fixing seat 420, such that the rear wheels 410 can be steered left and right, and in turn make the rear wheels 410 can be in a forward direction shown by the arrow in FIG. 1, a left steered direction (see FIG. 2) or a right steered direction (see FIG. 3). The forward direction here refers to the direction in which the rear wheels 410 point to the same direction as the forward direction of the stroller 1, i.e., the direction in which the wheels 410 point to as shown in FIG. 1.

According to this embodiment, the baby stroller 1 has a rear wheel steering mechanism 100 at the rear wheels 410. It can be seen from FIG. 1 that a cover body 140 of the rear wheel steering mechanism 100 is between the two rear wheels 410 or the two rear wheel mechanisms 400. The cover body 140, for example, is fixed on the frame 200 and can be selectively used for standing a child or placing articles. In order to lock and unlock the rear wheel steering mechanism 100, an unlock holding assembly (will be described in detail later) is provided. A button 135 of a release member 130 of the unlock holding assembly extends upward from a perforation on an upper surface of a back side of the cover body 140, and the user can press or step on the button 135 for releasing the rear wheels 410 from a drift locked state or enabling the rear wheels 410 to be in a drift unlocked state. When the rear wheels 410 is rotationally locked, the baby stroller 1 can only travel in a straight line, and when the rear wheels 410 is rotationally unlocked, the baby stroller 1 can rotate to the left or right by a certain angle (see FIGS. 2 and 3). According to the disclosure, rotatable angle range of the rear wheels 410 is preferably from 30° to 40° (including 30° and) 40°, but the disclosure is not limited to this.

FIG. 2 shows a perspective view of the stroller 1 according to the first embodiment of the disclosure, in which the rear wheels 410 are steered to the left and drifting.

Different from FIG. 1, according to FIG. 2, for example, by pressing or stepping on the release member 130, the rear wheels 410 is drift unlocked, such that in this case the rear wheels 410 is steered leftward in the left steered direction to a certain state.

FIG. 3 shows a perspective view of the stroller 1 according to the first embodiment of the disclosure, in which the rear wheels 410 are steered in drifting rightward. This figure shows the rear wheels 410 is steered rightward in the right steered direction to a certain state after being drift unlocked.

As can be seen from FIGS. 1 to 3, after the rear wheels 410 of the disclosure is unlocked from the drift locked state in a straight line along the forward direction, the rear wheels 410 can be rotated left and right by a certain angle, which improves the controllability of the baby stroller 1 in use.

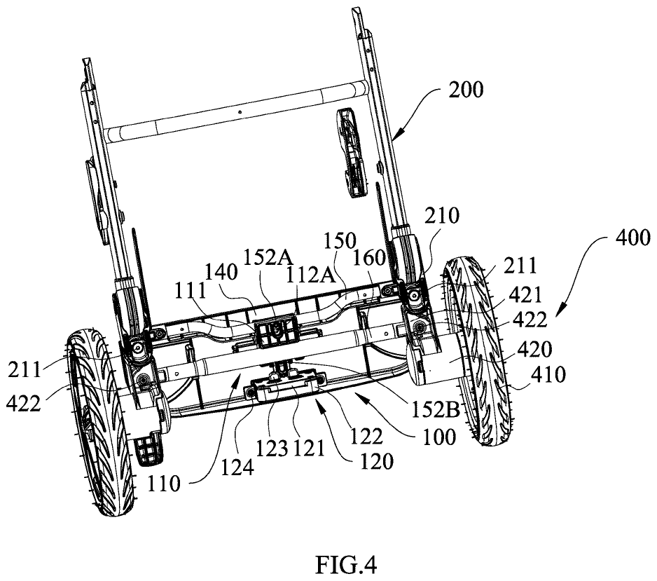

FIG. 4 shows a bottom view of a rear wheel steering mechanism 100 of the stroller 1 according to the first embodiment of the disclosure. This figure shows the remaining components of the rear wheel steering mechanism 100 covered by the cover body 140 in FIGS. 1 to 3. These components of the rear wheel steering mechanism 100 include a holding device 110, an accommodating mechanism 120, a crossbar 150, and a linkage member 160. The holding device 110, the accommodating mechanism 120, and the release member 130 including the button 135 which has been described above constitute the main components of the unlock holding assembly. The unlock holding assembly is used to enable a pair of the wheels 410 mounted on the wheel steering mechanism 100 to switch between the forward direction and the steered direction.

The crossbar 150 connects two wheel seats 210 of the baby stroller 1 or other parts of the frame 200 near the wheel seats 210. The wheel seats 210 are arranged on a lower side of the frame 200 and at the rear ends of the rods arranged in the forward direction, and are respectively pivotally connected to the wheel mechanisms 400, such that the two wheel mechanisms 400 can deviate from the forward direction in the left and right directions to realize the left and right drift of the rear wheels 410. In order to make the rear wheels 410 synchronously rotate left and right by a certain angle to realize stable steering drift, according to the disclosure, the crossbar 150 is arranged on the two wheel seats 210 or other parts of the frame 200 near the wheel seats 210, such that it can limit forward position of the holding device 110 of the rear wheel steering mechanism 100 (will be described in detail later).

According to the disclosure, the linkage member 160 is pivotally arranged between the fixing seats 420 of the rear wheels 410 or preferably between connecting portions 421 of the fixing seats 420 connected to the wheel seats 210, such that the two rear wheels 410 can be rotated in linkage while drifting left and right, and at the same time, a backward position of the holding device 110 of the rear wheel steering mechanism 100 is advantageously limited (will be described in detail later). The crossbar 150 and the linkage member 160 are arranged in parallel in the horizontal direction.

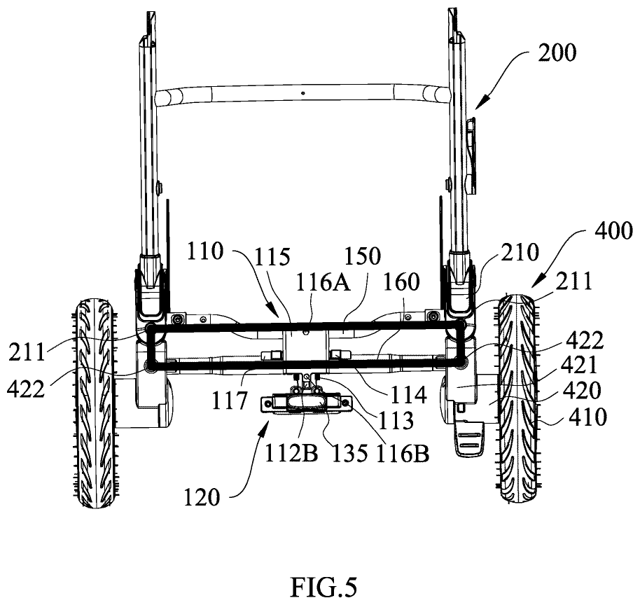

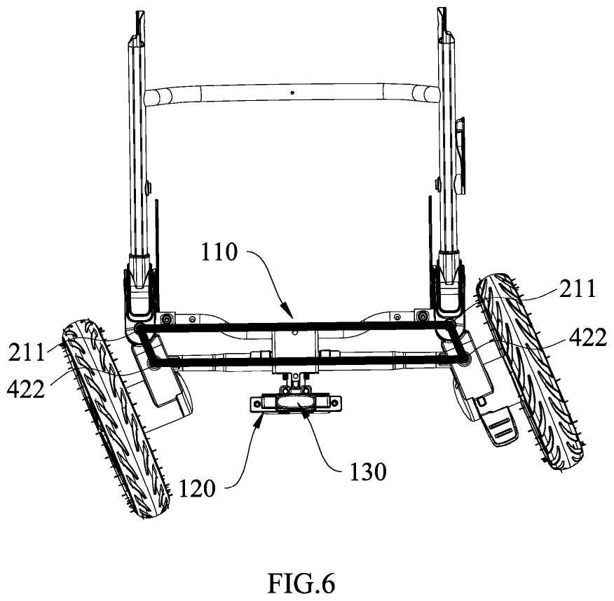

Two pivot points 211 of the wheel seats 210 and the fixing seat 420, and two pivot points 422 of the linkage member 160 and the fixing seat 420 or the connecting portions 421, as shown in FIG. 4, form a rectangular mechanical structure in the case that the rear wheels 410 is in the forward direction (see the four-point connection in FIG. 5), and the rectangular mechanical structure will be deformed into a non-rectangular parallelogram mechanical structure in the case that the rear wheels 410 are steered leftward or rightward (see the four-point connection in FIG. 6). According to the above-mentioned mechanical structural relationship, the above four pivot points 211 and 422, e.g., in the form of dots, are arranged for the rear wheels 410 to rotate in drifting. When drift is unlocked, the rear wheels 410 can rotate to leftward or rightward by a certain angle around the four dots. When the rear wheels 410 rotate (drift), the linkage member 160 can be displaced parallel and/or perpendicular to the crossbar 150. As a result, the two rear wheels 410 can stably move synchronously while being steered left and right in linkage, thus realizing a drifting steering of the rear wheels 410 of the baby stroller 1.

According to the disclosure, in order to keep the distance between the linkage member 160 and the crossbar 150 when the linkage member 160 moves in the front-back direction, and further obtain a stable left-right steering rotation angle, a holding device 110 is arranged between the linkage member 160 and the crossbar 150. The blocking member 111 of the holding device 110 can be seen in FIG. 4. A front side of the blocking member 111 abuts against the crossbar 150, and a first guide post 152A passes through a first long slot 112A in the blocking member 111 and a penetrating hole 151 in the crossbar 150 (not shown), thereby fixing the protective cover 115 and the crossbar 150, and enabling the blocking member 111 to be guided to move back and forth vertically to the crossbar 150. A rear side of the blocking member 111 may partially or entirely abut against the linkage member 160, such that when the linkage member 160 moves forward, it brings the blocking member 111 to move towards the crossbar 150 and keeps the linkage member 160 at a certain distance from the crossbar 150. In order to realize a backward displacement of the blocking member 111, a tension spring 113 is provided according to the disclosure, and preferably two tension springs 113 are provided. According to this embodiment, one end of each tension spring 113 is connected to the blocking member 111, and the other end of each tension springs 113 is connected to the accommodating mechanism 120 for accommodating the release member 130 (not shown in this figure), but it may also be connected to the lower side of the cover body 140, for example.

The accommodating mechanism 120 is connected to the lower side of the cover body 140 through the connecting portions 124, and includes a bottom cover 122 and a lower cover 121. The bottom cover 122 and the lower cover 121 enclose an accommodation space for accommodating the release member 130 (not shown). A side of the lower cover 121 facing the blocking member 111 is provided with tension spring contact points 123, e.g., in the form of contact tabs for connecting the tension springs 113. Through the accommodating mechanism 120 fixedly connected to the cover body 140, when the linkage member 160 is displaced in a direction away from the crossbar 150 due to the rear wheels 410 returning from the steered direction to the forward direction, the blocking member 111 can be moved backward in a reset manner due to contraction of the tension springs 113, and thus attaches to the linkage member 160.

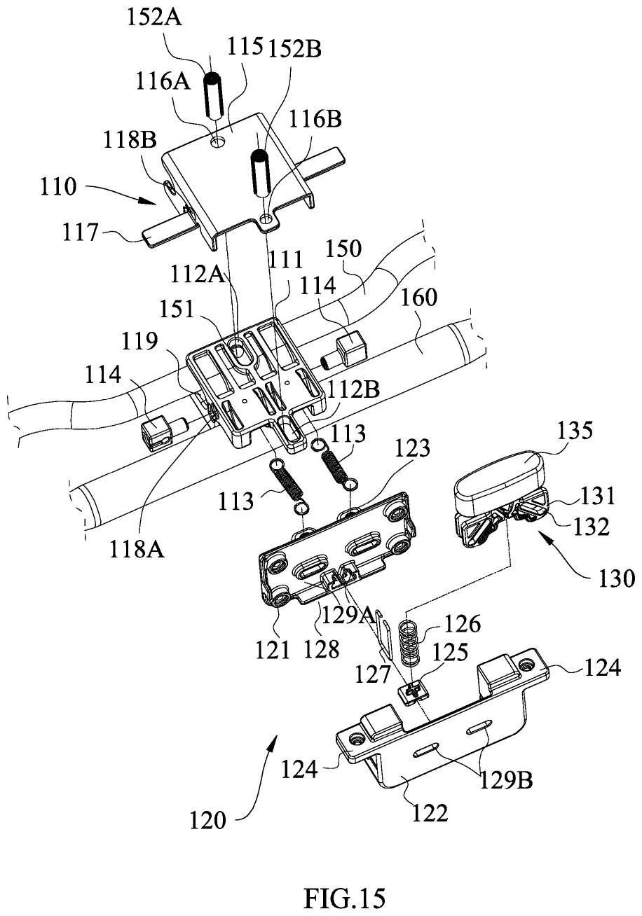

FIG. 5 shows a top view of the rear wheel steering mechanism 100 of the stroller 1 according to the first embodiment of the disclosure. In FIG. 5, the cover body 140 is removed, and the button 135 of the release member 130 accommodated in the accommodating mechanism 120 is shown. The blocking member 111 shown in FIG. 4 is covered by the protective cover 115, and the protective cover 115 is fixedly connected to the cover body 140 or integrally formed with the cover body 140. The protective cover 115 has a first protective cover hole 116A corresponding to the positions of the first long slot 112A of the blocking member 111 and the penetrating hole 151 of the crossbar 150 in FIG. 4, and the first guide post 152A passing through the first long slot 112A and the penetrating hole 151 may also pass through the protective cover hole 116A. According to this embodiment, the protective cover 115 preferably has a second protective cover hole 116B on the other side of the linkage member 160. The second protective cover hole 116B is used to cooperate with a corresponding second long slot 112B of the blocking member 111, such that the second guide post 152B may pass through the second protective cover hole 116B and the second long slot 112B, so as to better realize position defining with the blocking member 111 and realize the guided forward and backward displacement of the blocking member 111. In FIG. 5, a guide rail 117 of the holding device 110 and a locking member 114 arranged on the guide rail 117 can also be identified. The locking member 114 and the guide rail 117 are preferably arranged on two sides of the protective cover 115 and the blocking member 111. According to the disclosure, the guide rail 117 is integrally provided on the protective cover 115 (see FIG. 15), so as to hold and guide the left-right movement of the locking member 114. The locking member 114 is operatively arranged on the guide rail 117 of the protective cover 115, and has a locked position and an unlocked position in respect to the blocking member 111. According to other embodiments, the guide rail 117 and the locking member 114 may be arranged on the cover body 140, or the guide rail 117 and the locking member 114 may be arranged on the linkage member 160.

In the locked position, the locking member 114 locks the blocking member 111 between the linkage member 160 and the crossbar 150, such that the linkage member 160 is stationary relative to the crossbar 150. In the unlocked position, the locking member 114 unlocks the blocking member 111, such that the linkage member 160 and the crossbar 150 can slide or move relatively. That is, when the locking member 114 is inserted into the blocking member 111, it is used to lock the wheel mechanisms 400 in the forward direction, and the locking member 114 is pulled out from the blocking member 111 after being unlocked via the operatively coupled release member 130, such that the wheel mechanisms 400 can be steered in linkage. Specifically, when the rear wheels 410 is in the forward position, the locking member 114 may be inserted into the blocking member 111, for example, so as limit forward and backward displacement of the blocking member 111. In FIG. 5, the locking member 114 can be in a locked state to be inserted into the blocking member 111, so as to lock the wheels 410 in the forward direction. At this time, the button 135 is not pressed or stepped down, and the case shown in this figure, the locking member 114 can also be in an unlocked state in which it is only pulled out from the blocking member 111 but still being partially in the protective cover 115, such that the wheels 410 is in a state in which it can be steered left and right at any time. At this time, the button 135 should be pressed or stepped down.

FIG. 6 shows a top view of the rear wheel steering mechanism 100 of the stroller 1 according to the first embodiment of the disclosure. In FIG. 6, the rear wheels 410 are steered in drifting leftward, and the button 135 is in a pressed or stepped down state.

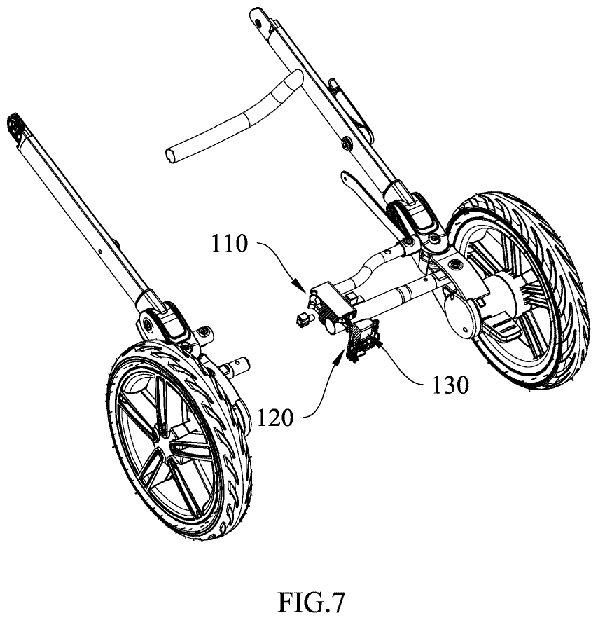

FIG. 7 shows a perspective view of the rear wheel steering mechanism 100 of the stroller 1 according to the first embodiment of the disclosure. In FIG. 7, the holding device 110, the accommodating mechanism 120, and the release member 130 of the unlock holding assembly are cut open, the rear wheels 410 is in the forward direction, and the locking member 114 can be in the inserted state or the pulled-out state.

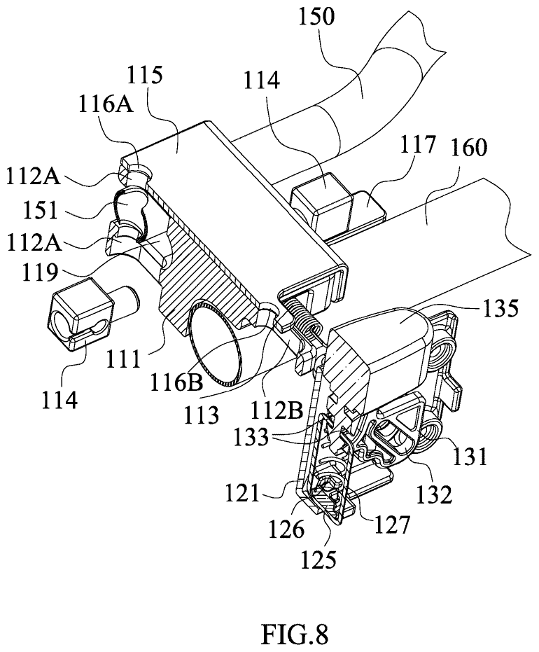

FIG. 8 shows an enlarged view of the holding device 110, the accommodating mechanism 120, and the release member 130 of the unlock holding assembly which are shown cut open in FIG. 7, and shows the crossbar 150 and the linkage member 160 at the same time.

In FIG. 8, the penetrating hole 151 in the crossbar 150 for guiding the first guide post 152A, and the first protective cover hole 116A of the protective cover 115 can be seen. The blocking member 111 has a U-shaped guide portion 119 located at a front end and crossing over the crossbar 150. The U-shaped guide portion 119 has an opening that opens forward for mounting the crossbar 150, and the crossbar 150 can move inside the U-shaped guide portion 119. On two legs of the U, there are two corresponding first long slots 112A parallel to a stretching direction of the tension springs 113 on the top wall and bottom wall of the U-shaped guide 119. Among them, the first guide post 152A (not shown) passes through the first protective cover hole 116A at a position overlapping with the crossbar 150, the two first long slots 112A and the corresponding penetrating hole 151 in the crossbar 150, so as to fix the position of the blocking member 111 in the longitudinal direction of the crossbar 150 and guide the blocking member 111 to move close to or away from the crossbar 150 along the stretching direction of the tension springs 113. On the other side of the linkage member 160, the protective cover 115 and the blocking member 111 have a second protective cover hole 116B and a second long slot 112B in the same form as the first protective cover hole 116A and the first long slots 112A, such that another guide post (not shown) can guide the forward and backward displacement of the blocking member 111.

Since the rear wheels 410 is in the forward direction in FIG. 7, the locking member 114 can be in an inserted state or a pulled out state on the guide rail 117 accordingly.

The accommodating mechanism 120 is connected to the blocking member 111 via the tension springs 113, and the tension springs 113 is connected to the lower cover 121 of the accommodating mechanism 120. After the bottom cover 122 of the accommodating mechanism 120 is removed, details of the internal components of the accommodating mechanism 120 and the release member 130 can be seen in FIG. 8.

The internal components of the accommodating mechanism 120 include: a compression spring 126, supported between the button 135 and a bottom of the accommodating mechanism 120 and respectively fixed with the button 135 and the bottom of the accommodating mechanism 120; a positioning member 127 for positioning the release member 130; and a fixing member 125 for pivotally fixing the positioning member 127 and supporting the compression spring 126 at an end on the bottom of the accommodating mechanism 120.

The release member 130 includes a button 135, a dragging portion 131 connected to a lower side of the button 135, a chute 132 in the dragging portion 131, and a passage portion 133. The dragging portion 131 moves up and down with the button 135, and is used to pull a dragging member 134 (not shown) of the release member 130 inside the chute 132, such that it is dragged due to the up and down movement of the dragging portion 131, so as to bring the locking member 114 to be pulled out of the blocking member 111. The passage portion 133 has a plurality of grooves 133A, 133B, 133C, 133D, 133E. The specific structures and functions of the plurality of grooves 133A, 133B, 133C, 133D, 133E will be explained in detail later with reference to other drawings.

According to the disclosure, with pressing or stepping down, the other movable end of the positioning member 127 can be moved in a positioning manner at the plurality of grooves 133A, 133B, 133C, 133D, 133E of the passage portion 133 of the release member 130 by means of the compression spring 126, so with the movement of the dragging portion 131, the dragging member 134 of the chute 132 brings the locking member 114 to be pulled out from the blocking member 111. As shown, the passage portion 133 is non-penetrating, and two free ends of a movable end of the positioning member 127 can be respectively clamped into the passage portions 133 on both sides. Moreover, the passage portion 133 may also be of a one-piece through-going type.

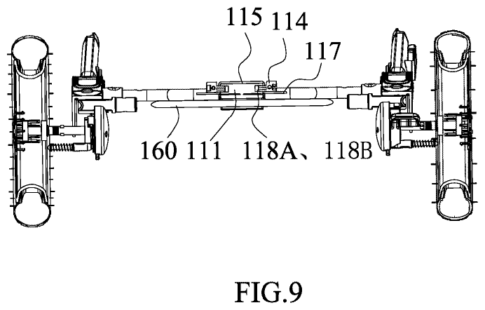

FIG. 9 shows a rear view of the rear wheel steering mechanism 100 of the stroller 1 according to the first embodiment of the disclosure. In this figure, the holding device 110 is cut open, and the locking member 114 is in an inserted state or locked state to be inserted into the blocking member 111. For this, the blocking member 111 has locking slots 118A on both sides and the protective cover has locking slots 118B on both sides, and the locking members 114 arranged on the guide rails 117 on both sides of the protective cover 115 can be guided and inserted into the locking slots 118A, 118B when the rear wheels 410 is in the forward direction, such that the drift steering of the rear wheels 410 can be locked.

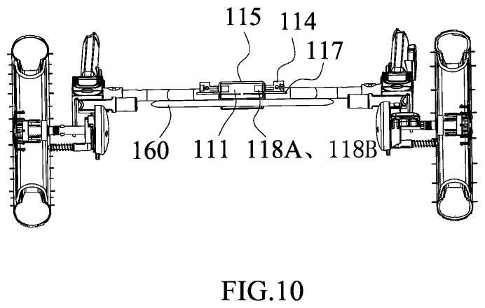

FIG. 10 shows a rear view of the rear wheel steering mechanism 100 of the stroller 1 according to the first embodiment of the disclosure. In this figure, the holding device 110 is cut open, and the locking members 114 are in the pulled-out state. It would be pointed out, the locking members 114 are pulled out from openings of the protective cover 115 in this embodiment, however, the locking members 114 can also be pulled out only from the locking slots 118A of the blocking member 111 (see FIG. 15), and their ends are still in the locking slots 118B (see FIG. 15) of the protective cover 115. In FIG. 10, the rear wheels 410 are in the forward direction, and the blocking member 111 has been unlocked by the locking members 114, so the baby stroller 1 can be steered to any direction at any time.

In FIGS. 9 and 10, other embodiments of the linkage member 160 are exemplarily shown, and the linkage member 160 can be coupled to connecting tubes or joints on both sides of the stroller through various possible forms. Unlike, for example, the embodiment in which a middle diameter of the linkage member 160 shown in FIG. 5 is larger than diameters of both ends, the linkage member 160 shown in FIGS. 9 and 10 is smaller in diameter than the joints at both sides of the stroller 1, and the linkage member 160 is indirectly connected to the joints through other connectors. By the exemplary embodiments, the linkage member 160 can be flexibly designed to adapt to other parts of the stroller, such as the blocking member. In addition, the linkage member 160 may not be changed in diameter.

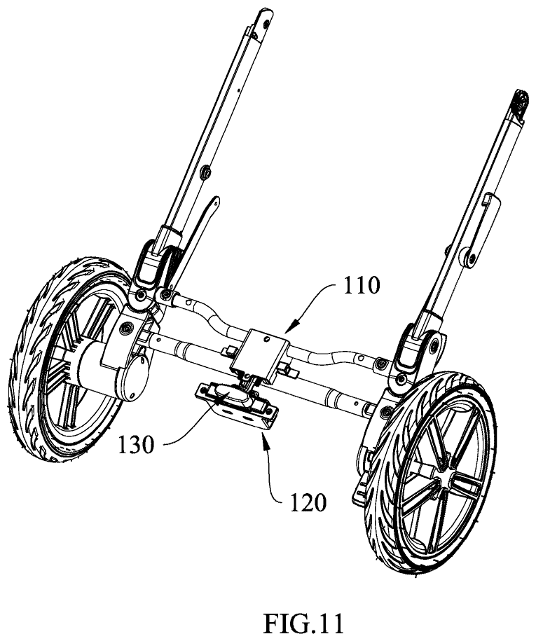

FIGS. 11 to 15 show the holding device 110, the accommodating mechanism 120, and the release member 130 from different angles.

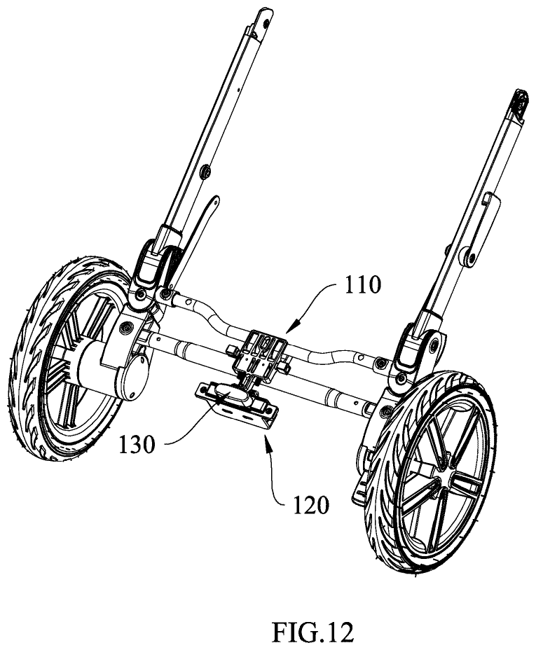

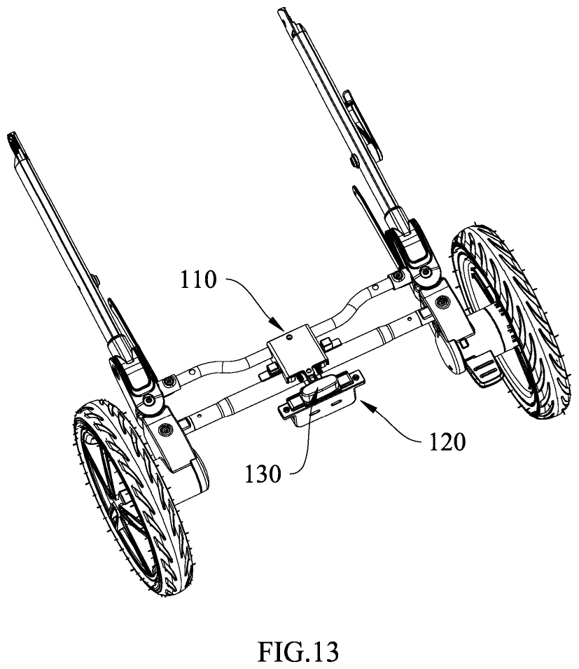

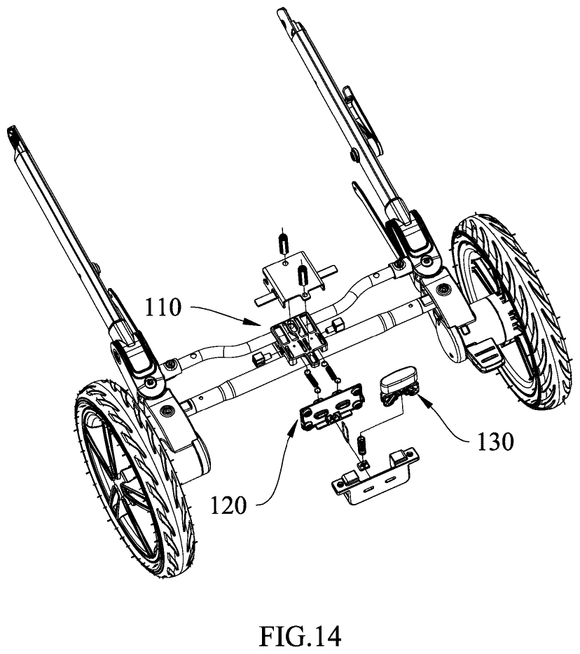

FIG. 11 shows a perspective view of the rear wheel steering mechanism 100 of the stroller 1 according to the first embodiment of the disclosure, in which the holding device 110 is provided with a protective cover 115. FIG. 12 shows the holding device 110 of FIG. 11, in which the holding device 110 is provided without the protective cover 115. FIG. 13 shows a perspective view of the rear wheel steering mechanism 100 of the stroller 1 from the opposite side of FIG. 11, in which the holding device 110 is provided with the protective cover 115. FIG. 14 shows a perspective view of the rear wheel steering mechanism 100 of the stroller 1 of FIG. 13, in which the holding device 110, the accommodating mechanism 120, and the release member 130 are shown in an exploded view.

FIG. 15 shows an exploded view of the holding device 110, the accommodating mechanism 120, and the release member 130 of FIG. 14 with enlarged details.

According to this embodiment, at the penetrating hole 151 of the crossbar 150, the holding device 110 is arranged between the crossbar 150 and the linkage member 160, and has a blocking member 111 and a protective cover 115 covering the blocking member 111.

On one side of the linkage member 160, the blocking member 111 has U-shaped guide portion 119 crossing over the crossbar 150, and the U-shaped guide portion 119 has two first long slots 112A parallel to the stretching direction of the tension springs 113 and located at two sides of the penetrating hole 151. On the other side of the linkage member 160, the blocking member has one second long slot 112B which is consistent with the form and direction of the above two first long slots 112A, and the second long slot 112B may be arranged on a protrusion as shown in the figure, for example, so as to save materials. On sides of the two blocking member 111, which are transverse to the longitudinal direction of the first long slots 112A and the second long slot 112B, a locking slot 118A is arranged for operatively coupling, especially inserting the locking members 114.

The protective cover 115 has an outer shape adapted to the blocking member 111, and has a first protective cover hole 116A and a second protective cover hole 116B corresponding to the first long slot 112A and the second long slot 112B, two locking slots 118B corresponding to the locking slots 118A, and guide rails 117 extending from two sides. The guide rails 117 are aligned with the locking slots 118B for holding the locking members 114 and guiding the locking members 114 to slide.

In case that the assembly is completed, the guide post 152A passes through the two first long slots 112A and the penetrating hole 151, and is inserted into the first protective cover hole 116A, so as to guide the blocking member 111 to slide perpendicular to the crossbar 150.

According to this embodiment, the accommodating mechanism 120 has a bottom cover 122 and a lower cover 121. The bottom cover 122 and the lower cover 121 enclose an accommodation space for accommodating the release member 130, and a compression spring 126, a fixing member 125, and a positioning member 127 are arranged inside the accommodation space. The cooperation relationship of the compression spring 126, the fixing member 125, and the positioning member 127, for example, is illustrated in FIG. 8 and will be explained again later. A side of the lower cover 121 facing the blocking member 111 is provided with tension spring contact points 123 in the form of contact tabs for connecting the tension springs 113. The bottom cover 122 has connecting portions 124 at both ends for connecting to the lower side of the cover body 140, and the connecting portions 124 are in the form of through holes for passing through fixing elements such as screws. A receiving portion 128 for clamping the fixing member 125 is arranged on the lower sides of the lower cover 121 and the bottom cover 122, and only half of the receiving portion 128 on the lower cover 121 can be seen in the figure.

According to this embodiment, the release member 130 has a button 135 and a dragging portion 131 connected to a lower side of the button 135. Chutes 132 symmetrically arranged on both sides of the dragging portion 131 can be clearly seen the figure. The chutes 132 are used for receiving the dragging members 134 connected to the locking members 114.

According to this embodiment, at least one of the bottom cover 122 and the lower cover 121 is provided with transverse slots 129A and 129B corresponding to the chutes 132, and an end of the dragging member 134 can also be arranged to pass through and move along the transverse slots 129A and 129B.

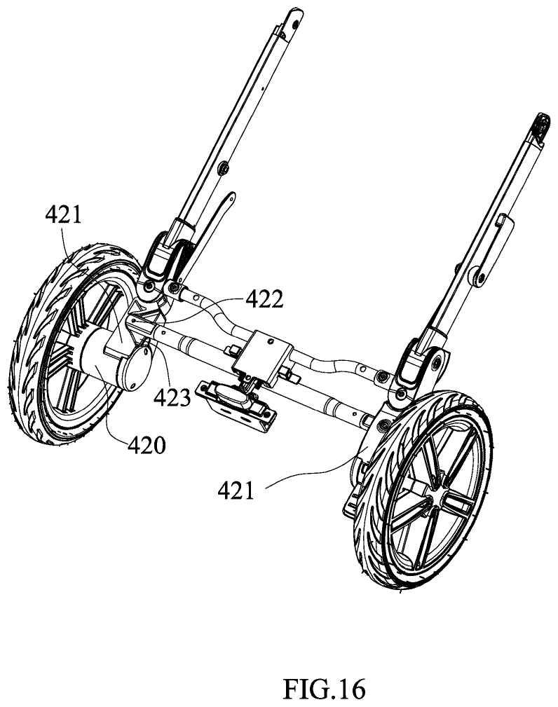

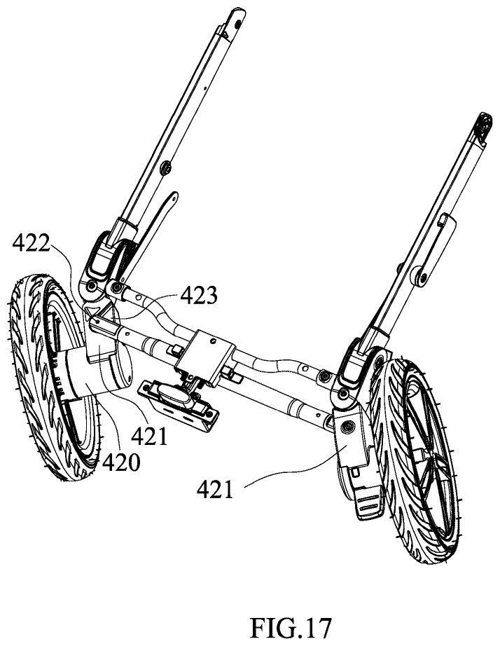

FIG. 16 shows a perspective view of the wheel mechanisms 400 according to the first embodiment of the disclosure at rear wheels of the stroller 1, in which the rear wheels 410 are in the forward direction. FIG. 17 shows a perspective view of the wheel mechanisms 400 according to the first embodiment of the disclosure at the rear wheels 410 of the stroller 1, in which the rear wheels 410 are steered in drifting leftward.

FIGS. 16 and 17 mainly show the connecting portions 421 between the fixing seats 420 of the wheel mechanisms 400 and the wheel seats 210 of the frame 200. What differs the left connecting portion 421 from the right connecting portion 421 lies in that the cover part is removed from the left connecting portion 421, such that a notch 423 inside the connecting portion 421 can be seen in a bell mouth shape, and the linkage member 160 is pivotally connected to the connecting portions 421 at the bottom of the bell mouth through the pivot point 422. The notch advantageously prevents the connecting portion 421 from interfering with the linkage member 160 when the rear wheels 410 rotate. FIG. 16 shows a state before the rear wheels 410 rotate, and FIG. 17 shows a state after the rear wheels 410 rotate.

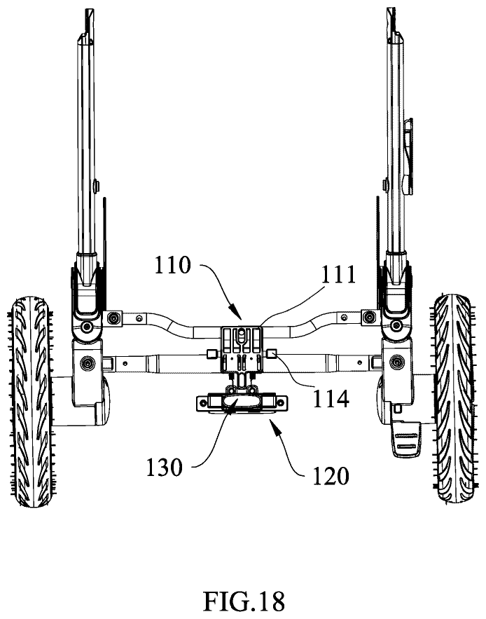

FIGS. 18 to 25 show the operation of the release member 130.

FIG. 18 shows a top view of the rear wheel steering mechanism 100 of the stroller 1 according to the first embodiment of the disclosure, in which the rear wheels 410 are in the forward direction. In this figure, the release member 130 is not pressed or stepped down, the locking members 114 is locked in the blocking member 111, the rear wheels 410 is in a drift locked state, and the baby stroller 1 can only move forward.

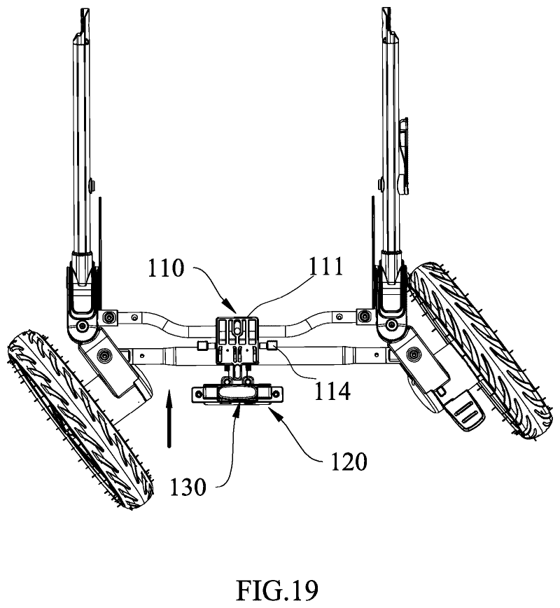

FIG. 19 shows a top view of the rear wheel steering mechanism 100 of the stroller 1 according to the first embodiment of the disclosure, in which the rear wheels 410 are steered in drifting leftward. In this figure, the release member 130 is pressed or stepped down, the locking members 114 are pulled out of the blocking member 111, the rear wheels 410 are in a driftable steered state, and the baby stroller 1 can be steered.

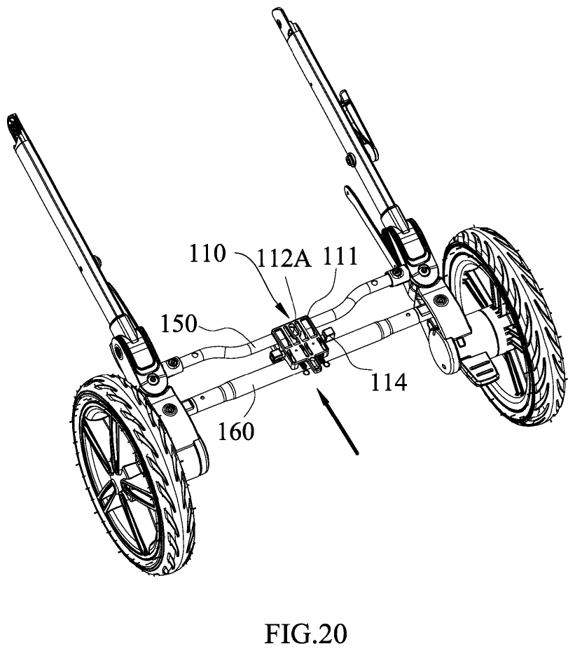

FIG. 20 shows a perspective view of the rear wheel steering mechanism 100 from another angle, in which only a holding device 110 having no protective cover 115 is provided, and the rear wheels 410 are in the forward direction. In this figure, the linkage member 160 is at a position far away from the crossbar 150, the guide post 152A (not shown) is at a first position, e.g., at the front end of the first long slot 112A along the first long slot 112A (along the direction of the single arrow), the blocking member 111 attaches to the linkage member 160 due to the action of the tension springs 113 (see FIG. 8), the locking members 114 are inserted into the blocking member 111, thereby realizing the drift locked state.

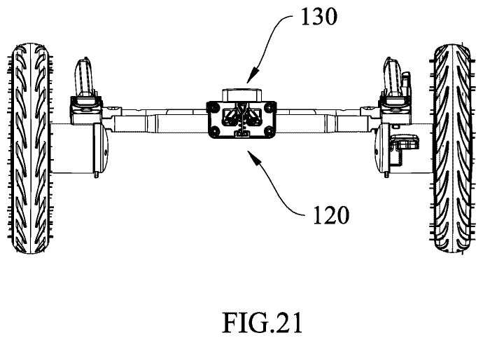

FIG. 21 shows a rear view of the rear wheel steering mechanism 100 of the stroller 1 in FIG. 20. This figure shows the accommodating mechanism 120 and the release member 130 in the locked state.

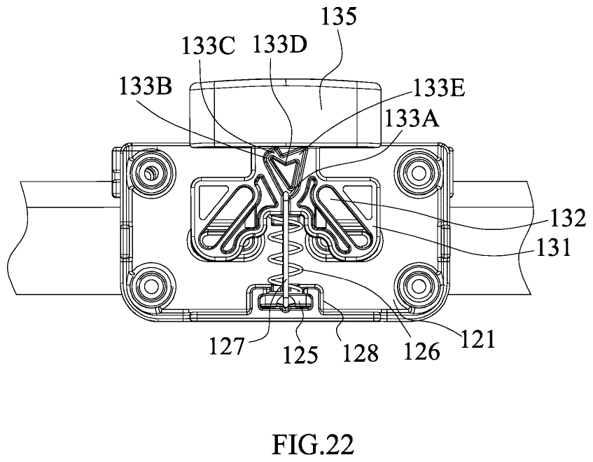

FIG. 22 shows an enlarged view of the accommodating mechanism 120 and the release member 130 in FIG. 21. At this time, the release member 130 is in the locked state for inserting or locking the locking members 114 shown in FIG. 20 into the blocking member 111. The button 135 of the release member 130 is not pressed or stepped down, the dragging portion 131 connected to the button 135 is at a highest position, and the dragging members 134 (not shown) respectively located in the two chutes 132 of the dragging portion 131 do not exert a pulling out action on the locking members 114, such that the locking members 114 are inserted into the blocking member 111 in FIG. 20. The fixing member 125 is clamped in the lower receiving portion 128 of the lower cover 121. The fixing member 125 pivotally fixes the lower end of the positioning member 127, and supports the compression spring 126. The positioning member 127 is used to position the dragging portion 131. An upper end or movable end of the positioning member 127 is located in the passage portion 133. The passage portion 133 includes a continuous passage with five grooves 133A, 133B, 133C, 133D, 133E, and the movable end of the positioning member 127 is currently in the groove 133A. At this time, the button 135 is not pressed or stepped down.

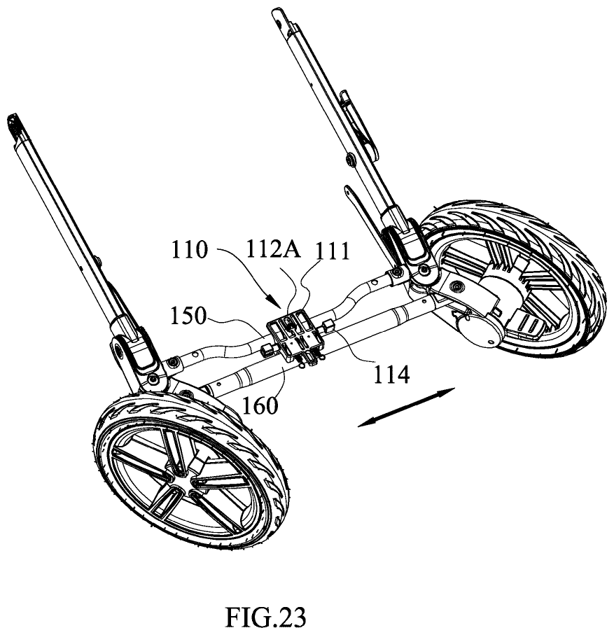

FIG. 23, opposite to FIG. 20, shows a top view of the rear wheel steering mechanism 100 of the stroller 1 according to the first embodiment of the disclosure, in which only a holding device 110 having no protective cover 115 is provided, the rear wheels 410 are steered in drifting leftward, and the locking members 114 are pulled out of the blocking member 111. In the state of being steered in drifting leftward, the linkage member 160 moves leftward in the direction of double arrows from the position shown in FIG. 20. In this moving process, due to the parallelogram relationship explained earlier, the linkage member 160 brings the blocking member 111 to move close to the crossbar 150 in the direction of the single arrow, and the blocking member 111 slides forward, such that the guide post 152A (not shown) is switched from the first position of the first long slots 112A to the second position, e.g., the rear end of the first long slot 112A (in the direction of the single arrow). At this time, the blocking member 111 attaches to the crossbar 150, thereby realizing the drift holding function of the rear wheels 410 at a favorable angle.

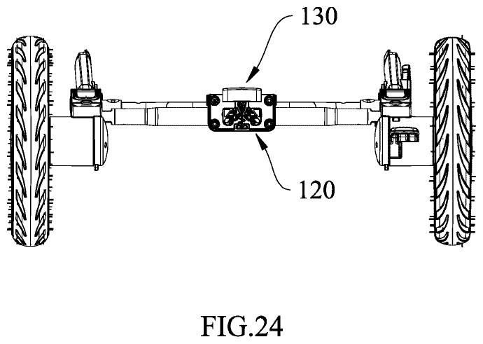

FIG. 24, corresponding to FIG. 21, shows a rear view of the rear wheel steering mechanism 100 of the stroller 1 in FIG. 23, in which an accommodating mechanism 120 and a release member 130 in the unlocked state are provided.

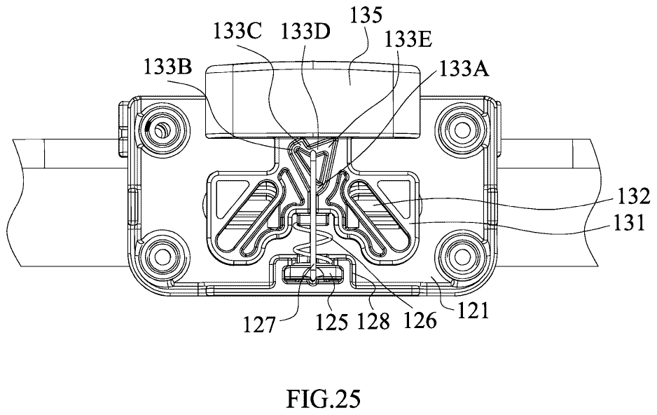

FIG. 25 shows an enlarged view of the accommodating mechanism 120 and the release member 130 in FIG. 24. As shown, the release member 130 is in the unlocked state at this time, the locking member 114 is pulled out of the blocking member 111, and the button 135 is pressed or stepped down once and is in a lower position (not the lowest position).

According to this embodiment (see FIGS. 22 and 25 simultaneously), the release member 130 is used for unlocking the locking member 114 by pulled out it from the blocking member 111 and locking the locking member 114 by inserting it into the blocking member 111 in the following manner:

In unlocking, as the button 135 of the release member 130 is pressed to a maximum stroke (i.e., it cannot be pressed any more), and then the users' hand or foot is released, the button 135 firstly brings the dragging portion 131 to move downwards together with the passage portion 133 and causes the compression spring 126 to be compressed, such that the movable end of the positioning member 127 moves upwards from the groove 133A along the passage portion 133 with the end fixed in pivot manner by the fixing member 125 as a pivoting shaft, and then turns to move towards the groove 133C after passing through the groove 133B of the passage portion 133 at the leftmost point in the figure. The button 135 reaches the maximum stroke at the groove 133C (the user's hand or foot is released at this time), and the movable end is finally stopped in the groove 133D as shown in FIG. 25 under the action of the compression spring 126 to reset the button 135. In such case, the chutes 132 also move downward, thereby brining the dragging members 134 or their heads (not shown) in the chutes 132 to move, such that the locking members 114 connected to the other ends of the dragging members 134 are pulled out from the locking slots 118A of the blocking member 111, so as to perform an unlocking; In locking, as the button 135 is pressed again to the maximum stroke (i.e., it cannot be pressed any more), and then the user's action of releasing hand or foot, the button 135 firstly brings the dragging portion 131 to move downwards together with the passage portion 133 such that the movable end of the positioning member 127 moves upwards from the groove 133D along the passage portion 133 with the end fixed in pivot manner by the fixing member 125 as a pivoting shaft, and reaches the groove 133E of the passage portion 133 at the rightmost point in the figure. The button 135 reaches the maximum stroke at the groove 133E, the user's hand or foot is released at this time, the movable end moves to the groove 133A under the action of the compression spring 126 to reset the button 135, and finally stops in the groove 133A as shown in FIG. 22. In such case, the chutes 132 also moves upward, thereby brining the dragging members 134 or their heads in the chutes 132 to move, such that the locking members 114 connected to the other ends of the dragging members 134 can be inserted into the locking slots 118A e of the blocking member 111, so as to perform a locking.

According to the above continuous process, locking and unlocking of the drift steering function can be easily realized by two times of non-continuous pressing or stepping in the disclosure, thereby facilitating the user's operation and use experience.

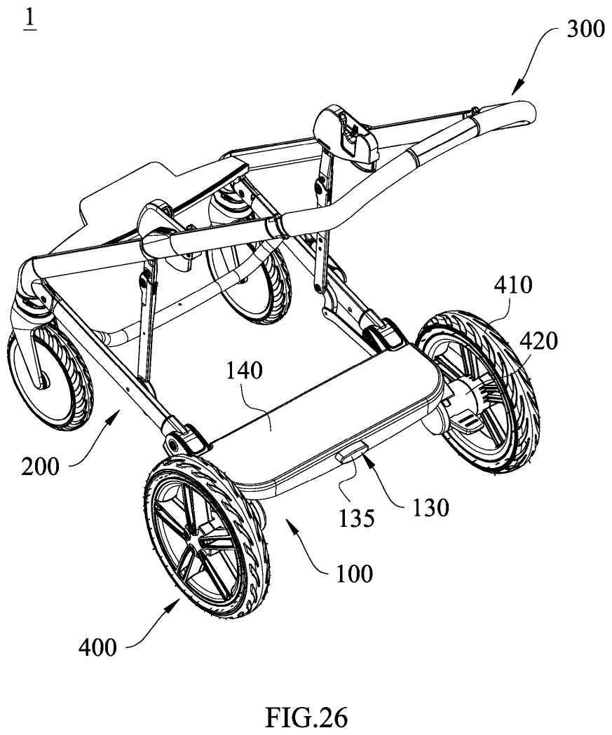

FIGS. 26 to 32 show the structure of the stroller 1 according to the second embodiment of the disclosure. Different from the first embodiment, the release member 130 of the wheel steering mechanism 1 in the second embodiment is arranged to extend horizontally from the rear side of the cover body 140, and the accommodating mechanism 120 and the release member 130 are horizontally arranged accordingly.

FIG. 26 shows a perspective view of the stroller 1 according to the second embodiment of the disclosure, in which the rear wheels are in the forward direction.

In the second embodiment, the stroller 1 can be especially a baby stroller 1 having a frame 200, a handlebar 300, four wheel mechanisms 400, and a wheel steering mechanism 100. The frame 200 is, for example, assembled from a plurality of preferably hollow rods by means of couplings, such that folding of the baby stroller 1 can be realized, for example. The handlebar 300 is assembled from preferably hollow rods likely, and is connected, especially plugged, to an upper portion of the frame 200 for pushing the baby stroller 1. In this embodiment, four wheel mechanisms 400 are symmetrically arranged in pairs on a lower side of the frame 200, two wheel mechanisms 400 at the front of the baby stroller are used for the front wheels 410 of the stroller, and two wheel mechanisms 400 at the rear of the baby stroller are used for the rear the rear wheels 410 of the stroller. The wheel mechanisms 400 for the rear wheels 410 of stroller has wheels 410 and fixing seats 420 respectively, and the fixing seats 420 are pivotally connected to the wheels 410 and pivotally coupled to the lower rear portion of the frame 200. The rear wheels 410 are pivotally connected to the frame 200 through the fixing seats 420, such that the rear wheels 410 can be steered left and right, and in turn make the rear wheels 410 can be in a forward direction, a left steered direction, and a right steered direction. The forward direction here refers to the direction in which the rear wheels 410 point to the same direction as the forward direction of the stroller 1, i.e., the direction in which the wheels 410 point to as shown in FIG. 26.

According to the second embodiment, the baby stroller 1 has a rear wheel steering mechanism 100 at the rear wheels 410. It can be seen from FIG. 26, a cover body 140 of the rear wheel steering mechanism 100 is between the two rear wheels 410 or the two rear wheel mechanisms 400. The cover body 140, for example, is fixed on the frame 200 and can be selectively used for standing a child or placing articles. A button 135 of a release member 130 of the rear wheel steering mechanism 100 extends horizontally backward from extends a perforation on a side face of the cover body 140, and the user can press or step on the button 135, for releasing the rear wheels 410 from a drift locked state. According to this embodiment, the upper surface of the cover body 140 will not be interfered by the button 135, so it will be smoother and more convenient for children to stand or put things. Specifically, the button 135 can control the rear wheel steering mechanism 100 to be in locked or unlocked state. When the Rotation of the rear wheels is locked, the baby stroller 1 can only travel in a straight line, and when the Rotation of the rear wheels 410 is unlocked, the baby stroller can rotate to the left or right by a certain angle. According to the disclosure, the rotatable angle range of the rear wheels 410 is preferably 30°-40°, but the disclosure is not limited to this.

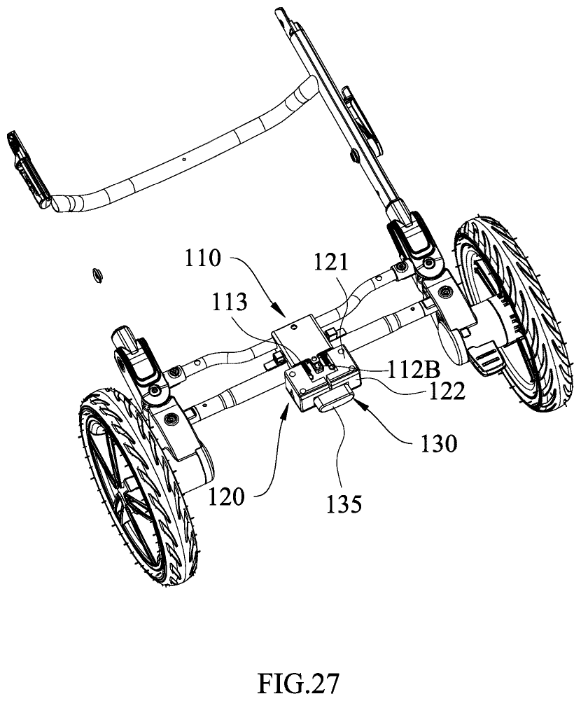

FIG. 27 shows a perspective view of the rear wheel steering mechanism 100 of the stroller 1 according to the second embodiment of the disclosure, in which the holding device 110 is provided with a protective cover 115. Different from the first embodiment, the accommodating mechanism 120 in this embodiment is arranged in the horizontal direction, the release member 130 extends horizontally backward from the accommodation space enclosed by the lower cover 121 and the bottom cover 122 of the accommodating mechanism 120, the tension springs 113 of the holding device 110 are horizontally fixed in the corresponding recesses in the lower cover 121, and the protrusions of the blocking member 111 for arranging the long slots 112B can also extend into the recesses. According to this embodiment, advantageously, the unlock holding assembly, that is, especially the holding device 110, the accommodating mechanism 120, and the release member 130, can be arranged more compactly.

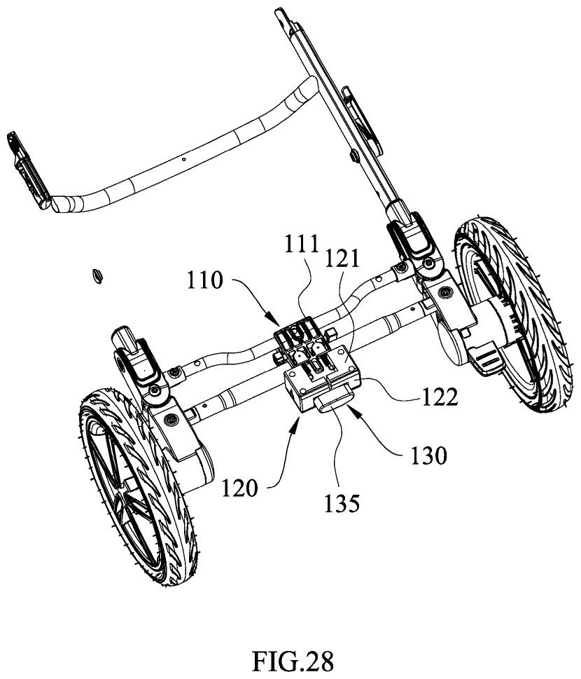

FIG. 28 shows a perspective view of the rear wheel steering mechanism 100 of the stroller 1 according to the second embodiment of the disclosure. As shown, the protective cover 115 is removed from the holding device 110. The holding device 110 of the second embodiment is basically as same as the holding device 110 of the first embodiment in terms of structure and function, but different in form only in the connection part between the tension springs 113 and the blocking member 111 (see FIG. 15). Two different embodiments of the connecting part are exemplarily illustrated, but the disclosure is not limited to this.

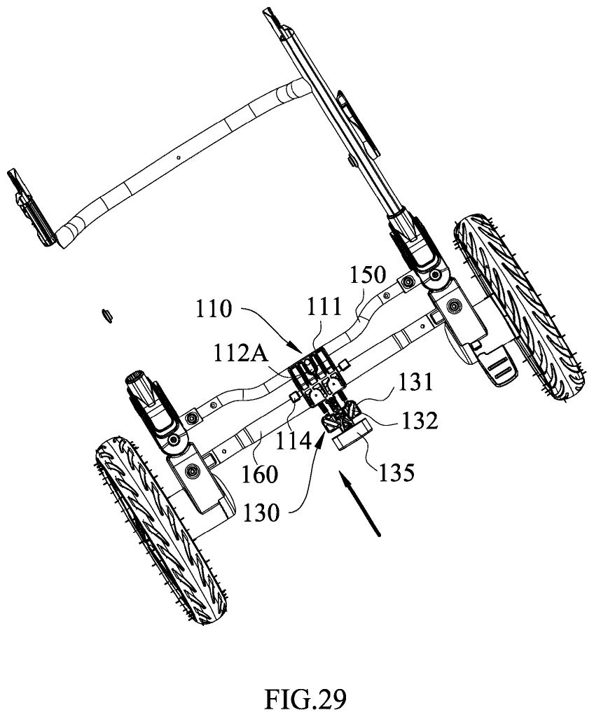

FIG. 29 shows a perspective view of the rear wheel steering mechanism 100 of the stroller 1 according to FIG. 28. As shown, the lower cover 121 and the bottom cover 122 of the accommodating mechanism 120 are removed, so as to better show the interactive relationship between the holding device 110 and the release member 130. At this time, the release member 130 is in a locked stat in which the locking members 114 are inserted into the blocking member 111. In FIG. 29, the linkage member 160 is at a position far away from the crossbar 150, the guide post 152A (not shown) is at a first position along the first long slot 112A, e.g., at the front end of the first long slot 112A (in the direction of single arrow), and the blocking member 111 attaches to the linkage member 160 (see FIG. 8) due to the action of the tension springs 113, thereby realizing the drift locked state.

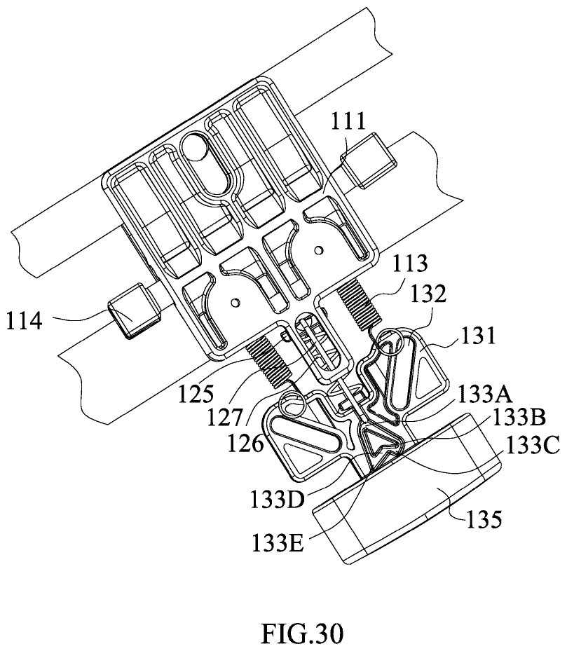

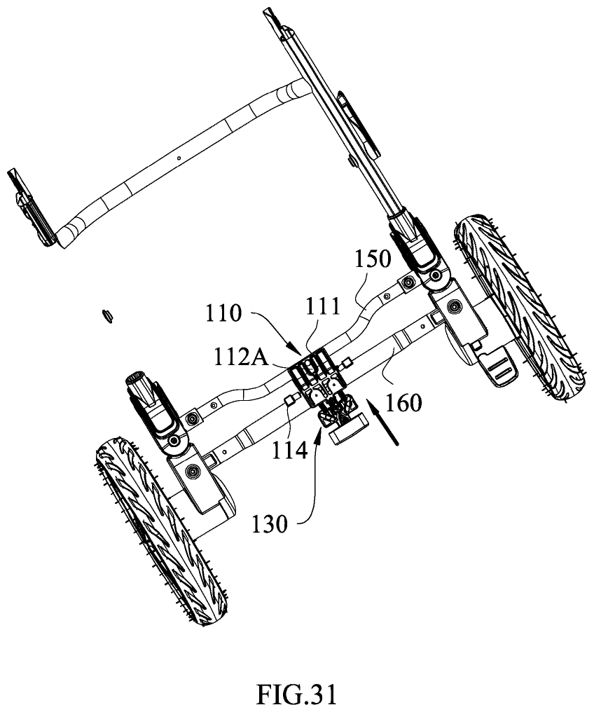

FIG. 30 shows an enlarged view of the holding device 110 and the release member 130 (which can be understood by referring to FIG. 22 of the first embodiment) in FIG. 29. As shown, the release member 130 is in the locked state at this time, the locking members 114 are inserted into the blocking member 111, and the button 135 is not pressed or stepped down and at the farthest position from the holding device 110. The ends of the tension springs 113 on the side of the release member 130 are currently in an unconnected and unstressed state. The compression spring 126, the positioning member 127, and the fixing member 125 belonging to the accommodating mechanism 120 cooperate with each other, such that the movable end of the positioning member 127 is currently located in the groove 133A of the passage portion 133. FIG. 31 shows a perspective view of the rear wheel steering mechanism 100 of the stroller 1. Compared with FIG. 29, the release member 130 is in the unlocked state at this time, and the locking members 114 are pulled out from the blocking member 111. In the state shown in FIG. 31, the linkage member 160 can move left and right approximately parallel to the crossbar 150. In the movement process, the linkage member 160 brings the blocking member 111 to move close to the crossbar 150 in the direction of the arrow, and the blocking member 111 slides forward, such that the guide post 152A (not shown) switches backward along the first long slots 112A to a second position, e.g., the rear ends of the first long slots 112A (in the direction of the single arrow), and at this time, the blocking member 111 attaches to the crossbar 150, such that the drift holding function of the rear wheels 410 can be realized at a favorable angle.

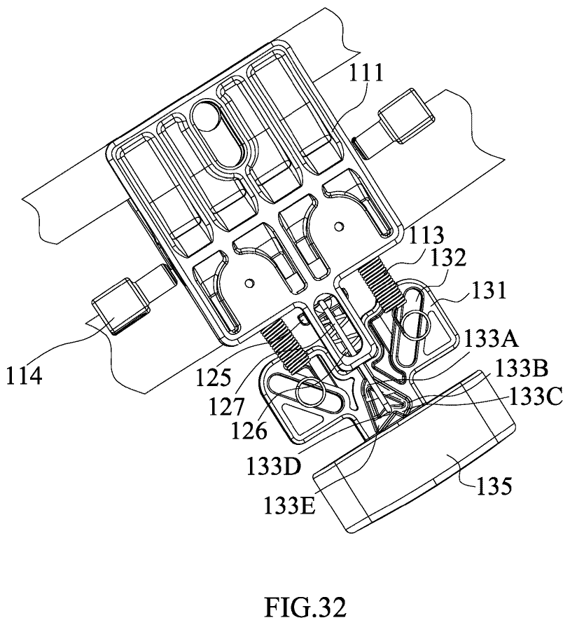

FIG. 32 shows an enlarged view of the holding device 110 and the release member 130 (can be understood by referring to FIG. 25 of the first embodiment) in FIG. 31. As shown, the release member 130 is in the unlocked state at this time, the locking members 114 are pulled out from the blocking member 111, and the button 135 is pressed or stepped once and is in a position close to the holding device 110 (not the closest position).

According to this embodiment (see FIGS. 30 and 32 simultaneously), the release member 130 is used to unlock the locking members 114 by pulling it out from the blocking member 111 and to lock the locking members 114 by inserting into the blocking member 111 in the following manner:

In unlocking, as the button 135 of the release member 130 is pressed to a maximum stroke (i.e., it cannot be pressed any more), and then the user's action of releasing hand or foot, the button 135 firstly brings the dragging portion 131 to move in a direction towards the holding device 110 together with the passage portion 133 and causes the compression spring 126 to be compressed, such that the movable end of the positioning member 127 moves out of the groove 133A along the passage portion 133 with the end fixed in pivot manner by the fixing member 125 as a pivoting shaft, and then turns to move towards the groove 133C after passing through the groove 133B of the passage portion 133 at the rightmost point in the figure. The button 135 reaches the maximum stroke at the groove 133C (the user's hand or foot is released at this time), and the movable end is finally stopped in the groove 133D as shown in FIG. 32 under the action of the compression spring 126 to reset the button 135. In such case, the chutes 132 also move downward, thereby brining the dragging members 134 or their heads (not shown) in the chutes 132, such that the locking members 114 connected to the other ends of the dragging members 134 are pulled out from the locking slots 118A of blocking member 111, so as to perform an unlocking;

In locking, as the button 135 is pressed again to the maximum stroke (i.e., it cannot be pressed any more), and then the user's action of releasing hand or foot, the button 135 firstly brings the dragging portion 131 to move in a direction towards the holding device 110 together with the passage portion 133, such that the movable end of the positioning member 127 moves out of the groove 133D along the passage portion 133 and moves to the groove 133E with the end fixed in pivot manner by the fixing member 125 as a pivoting shaft, and when it reaches the leftmost groove 133E of the passage portion 133 in the figure, the button 135 reaches the maximum stroke at the groove 133E. At this time, the user's hand or foot is released, and the movable end moves to the groove 133A under the action of the compression spring 126 to reset the button 135, and finally stops in the groove 133A as shown in FIG. 30. In such case, the chutes 132 also move upward, thereby brining the dragging members 134 or their heads in the chutes 132 to move, such that the locking members 114 connected to the other ends of the dragging members 134 can be inserted into the locking slots 118A of the blocking member 111, so as to perform a locking.

According to the above continuous process, locking and unlocking of the drift steering function can be easily realized by two times of non-continuous pressing or stepping in the disclosure, thereby facilitating the user's operation and use experience.

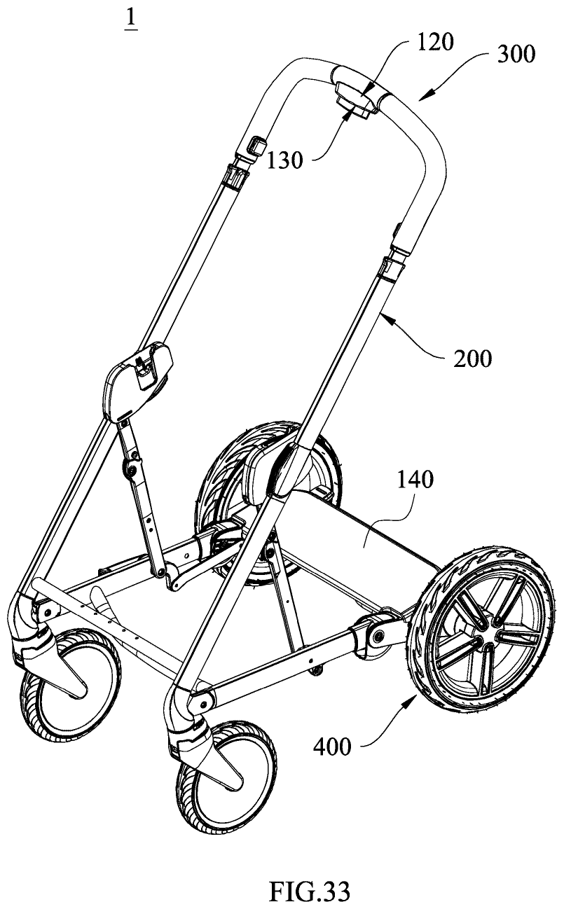

FIGS. 33 to 40 show the structure of the stroller 1 according to the third embodiment of the disclosure. Different from the first and second embodiments, the release member 130 and the accommodating mechanism 120 of the wheel steering mechanism 1 of the third embodiment are arranged on the handlebar 300. Other components of the wheel steering mechanism 1, especially the holding device 110 and the cover body 140, are arranged at the wheel mechanisms 400 as in the first and second embodiments. For sake of conciseness, structures and functions of the release member 130 and the accommodating mechanism 120 of the third embodiment will be mainly explained in detail.

FIG. 33 shows a front perspective view of a stroller 1 according to the third embodiment of the disclosure. As shown, the release member 130 and the accommodating mechanism 120 are arranged on the handlebar 300.

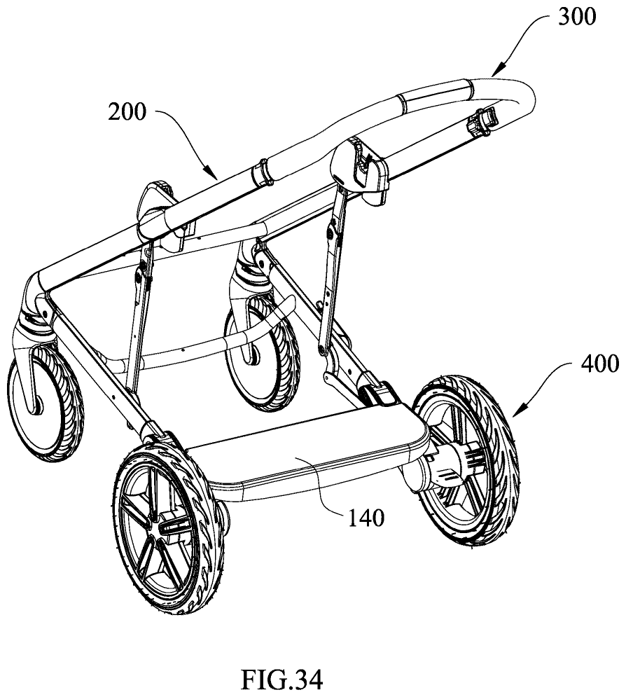

FIG. 34 shows a rear perspective view of the stroller 1 according to the third embodiment of the disclosure.

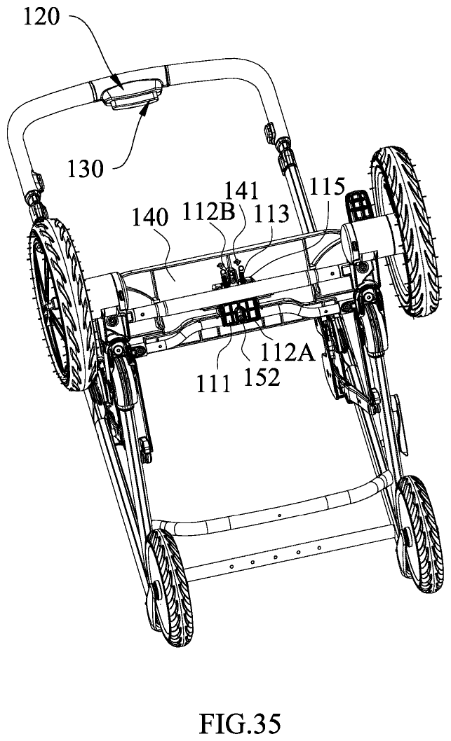

FIG. 35 shows an underside perspective view of the stroller 1 according to the third embodiment of the disclosure. As shown, the tension springs 113 of the holding device 110 in this example are fixed to a fixing portion 141 on a lower side of the cover body 140 instead of being fixed to the accommodating mechanism 120.

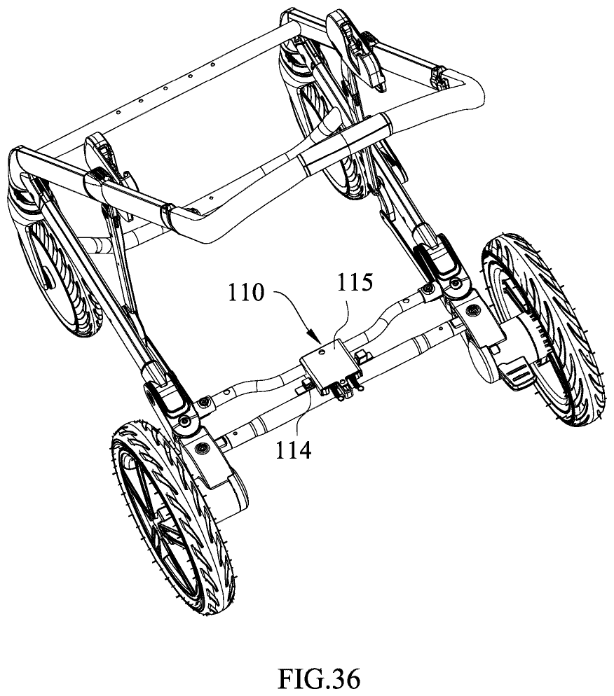

FIG. 36 shows a rear perspective view of the stroller 1 according to FIG. 34. As shown, the cover body 140 is removed, and the locking members 114 are inserted into the protective cover 115.

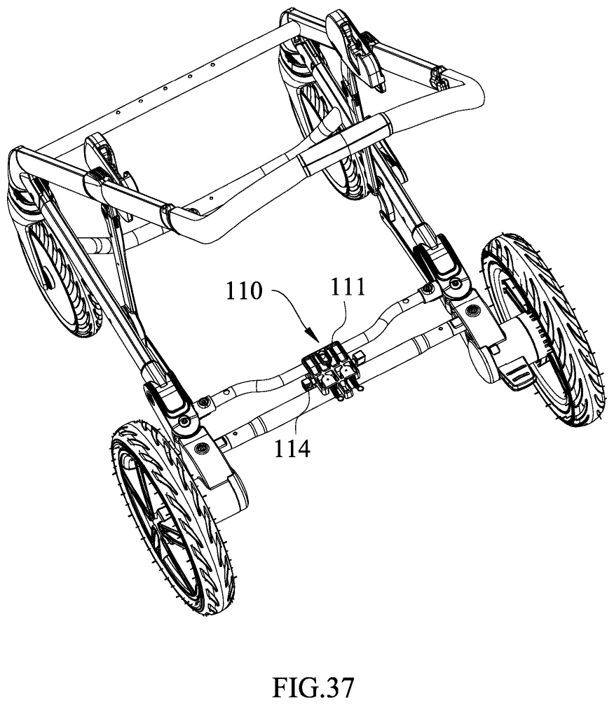

FIG. 37 shows a rear perspective view of the stroller 1 according to FIG. 36. As shown, the protective cover 115 of the holding device 110 is removed, the locking members 114 are inserted into the blocking member 111, and the rear wheels are locked in drift steering.

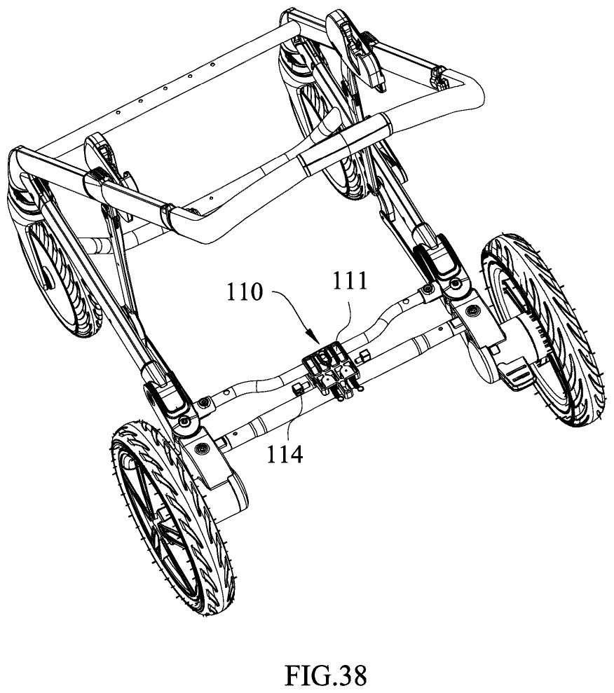

FIG. 38 shows a rear perspective view of the stroller 1 corresponding to FIG. 37. As shown, the protective cover 115 of the holding device 110 is removed, the locking members 114 are pulled out from the blocking member 111, and the rear wheels are unlocked from drift steering.

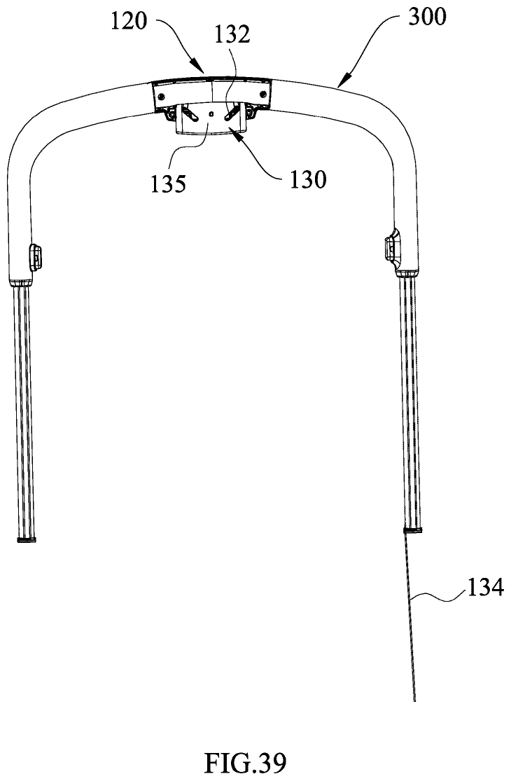

FIG. 39 shows a handlebar 300 according to the third embodiment of the disclosure. As shown, the release member 130 on the handlebar 300 is in a locked state in which the locking members 114 are inserted into the blocking member 111, the button 135 extends from the accommodating mechanism 120 to a maximum distance, and the chutes 132 is in a position where the dragging member 134 will not bring the locking members 114 connected to the other end of the dragging member 134 to slide out of the blocking member 111. The dragging member 134 may be arranged in hollow rods of the handlebar 300 and the frame 200.

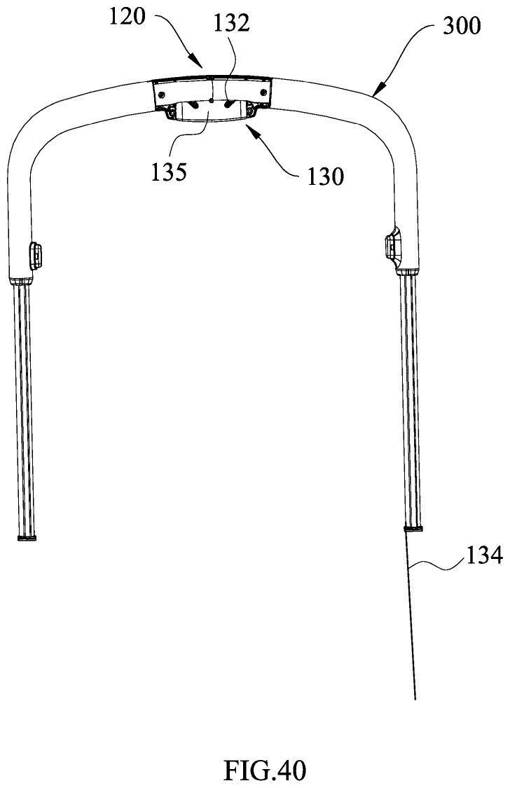

FIG. 40 shows the handlebar 300 according to the third embodiment of the disclosure. As shown, the release member 130 is in such unlocked state that the locking members 114 are pulled out from the blocking member 111, and the button 135 is partially pressed into the accommodating mechanism 120, such that the chutes 132 integrally made with the button 135 bring the dragging member 134 to move, thereby pulling the locking members 114 connected to the other end of the dragging member 134 out of the blocking member 111, and the rear wheels 410 are unlocked from drift steering.

According to the third embodiment, the user can easily press and control the release member 130 at the position of the handlebar 300 with a hand, so as to lock or unlock the locking members 114, and the dragging members 134 can be hidden in the hollow rods, which is beneficial to aesthetics.

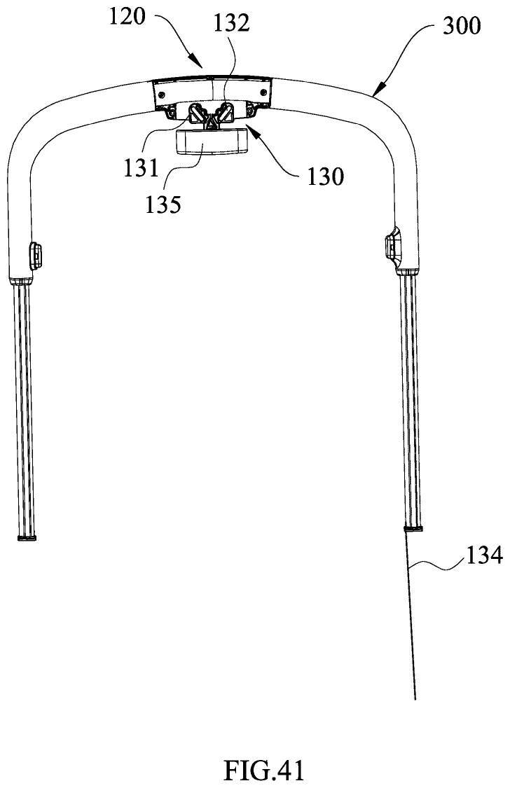

FIG. 41 shows the handlebar according to the third embodiment of the disclosure, in which the release member has a holding function. According to the third embodiment, it is also possible to design the holding device 110 of the first embodiment or the second embodiment at the handlebar 300, which can also realize the drift holding function of the disclosure. Specifically, in respect to the button 135 of the release member 130 shown in FIG. 39, an opening portion of the button 135 exposing the chutes 132 is schematically removed, so as to show the chutes 132 and, for example, the dragging portion 131. The structures and operations of the chutes 132 and the dragging portion 131 may refer to the specific description as shown in FIGS. 22 and 25 (first embodiment) and FIGS. 30 and 32 (second embodiment).

The technical effect of the disclosure is to provide a stroller 1, especially a stroller 1 with larger rear wheels 410, particularly a baby stroller 1, and the drift of the rear wheels 410, i.e., the steering in linkage of the two rear wheels 410 can be controlled within a certain range, so as to prevent the stroller 1 from being unstable, furthermore, the embodiments of the disclosure can provide drift holding function. The embodiments of the disclosure have advantages of being simple in structure and convenient in operation. The main points of the disclosure are when the button 135 of the release member 130 is operated, the dragging member 134 will bring the locking members 114 to unlock, and the rear wheels 410 will be held in the driftable state.

Since the application can be carried out in various forms without departing from the spirit and essence of the application, it should be understood that the above embodiments are not limited to any of the foregoing details, but should be interpreted as broadly as possible within the scope defined by the claims, and therefore all changes that fall within the scope of the claims or their equivalents should be covered by the claims.

List of reference signs

1: Stroller, Baby Stroller
100: Wheel Steering Mechanism, Rear Wheel Steering Mechanism
110: Holding Device
111: Blocking Member
112A: First Long Slot
112B: Second Long Slot
113: Tension Spring
114: Locking Member
115: Protective Cover
116A: First Protective Cover Hole
116B: Second Protective Cover Hole
117: Guide Rail
118A, 118B: Locking Slot
119: U-shaped guide Portion
120: Accommodating Mechanism
121: Lower Cover
122: Bottom Cover
123: Tension Spring Contact Point
124: Connecting Portion
125: Fixing Member
126: Compression Spring
127: Positioning Member
128: Receiving Portion
129A, 129B: Transverse Slot
130: Release member
131: Dragging Portion
132: Chute
133: Passage Portion
133A, 133B, 133C, 133D, 133E: Groove
134: Dragging Member
135: Button
140: Cover Body
141: Fixing Portion
150: Crossbar
151: Penetrating Hole
152A: First Guide Post
152B: Second Guide Post
160: Linkage Member
200: Frame
210: Wheel Seat
211: Pivot Point
300: Handlebar
400: Wheel Mechanism
410: Wheel, Front Wheel, Rear Wheel
420: Fixing seat
421: Connecting Portions
422 Pivot Point
423: Notch

1-24. (canceled)

25. A wheel steering mechanism for steering a wheel mechanism of a stroller, wherein the wheel steering mechanism comprises:
a linkage member for steering a pair of wheel mechanisms of the stroller in linkage;
a crossbar for connecting two wheel seats of the stroller, the wheel seats being respectively pivotally connected to the wheel mechanisms; and
a holding device, arranged between the linkage member and the crossbar, and used for holding the pair of wheel mechanisms to be steered in linkage.

26. The wheel steering mechanism according to claim 25, wherein the holding device has a locking member for locking the wheel mechanisms in a forward direction, and the locking member enables, after being unlocked, the wheel mechanisms to be steered in linkage.

27. The wheel steering mechanism according to claim 26, wherein the holding device has a guide rail for holding and guiding the locking member.

28. The wheel steering mechanism according to claim 26, wherein the holding device has a blocking member, and the blocking member is arranged between the linkage member and the crossbar.

29. The wheel steering mechanism according to claim 28, wherein when the wheel mechanisms are in the forward direction, the locking member is capable of being inserted into the blocking member to lock the wheel mechanisms in the forward direction.

30. The wheel steering mechanism according to claim 29, wherein the blocking member has a locking slot, and the locking member is capable of being inserted into the locking slot.

31. The wheel steering mechanism according to claim 29, wherein:
the wheel steering mechanism has a release member for unlocking the locking member from the blocking member, such that the wheel mechanisms are capable of being steered in linkage.

32. The wheel steering mechanism according to claim 31, wherein the release member unlocks the locking member and the blocking member through a dragging member.

33. The wheel steering mechanism according to claim 32, wherein the release member is arranged in an accommodating mechanism, and the accommodating mechanism is fastened on a lower side of a cover body covering the wheel steering mechanism.

34. The wheel steering mechanism according to claim 33, wherein the blocking member is connected to the accommodating mechanism or the cover body through a tension spring, such that when the wheel mechanisms returns to the forward direction, the blocking member is capable of moving away from the crossbar along with the linkage member.

35. The wheel steering mechanism according to claim 32, wherein the release member is arranged in an accommodating mechanism, and the accommodating mechanism is fastened on a handlebar of the stroller.

36. The wheel steering mechanism according to claim 35, wherein the blocking member is connected to a fixing portion arranged on a lower side of a cover body of the wheel steering mechanism through a tension spring, such that when the wheel mechanisms returns to the forward direction, the blocking member is capable of moving away from the crossbar along with the linkage member.

37. The wheel steering mechanism according to claim 34, wherein the blocking member has a first long slot, the crossbar has a penetrating hole, and a first guide post penetrates the first long slot and the penetrating hole, such that the blocking member is capable moving in respect to the crossbar.

38. The wheel steering mechanism according to claim 37, wherein the blocking member has a U-shaped guide portion connected to the crossbar, and the U-shaped guide portion has two first long slots parallel to a stretching direction of the tension spring.

39. The wheel steering mechanism according to claim 37, wherein the holding device has a protective cover for covering the blocking member, the protective cover has a first protective cover hole, and the first guide post is inserted into the first protective cover hole.

40. The wheel steering mechanism according to claim 39, wherein on a side of the linkage member opposite to the crossbar, the protective cover has a second protective cover hole, and the second protective cover hole and a second long slot of the blocking member are used for receiving a second guide post.

41. The wheel steering mechanism according to claim 39, wherein a guide rail is arranged on the protective cover, and the locking member is operatively arranged on the guide rail to achieve locking or unlocking to the blocking member.

42. The wheel steering mechanism according to claim 33, wherein the release member has a dragging portion, and the dragging member is dragged in a chute of the dragging portion due to a movement of the dragging portion, such that the locking member unlocks the blocking member.

43. The wheel steering mechanism according to claim 42, wherein:
the accommodating mechanism has:
a bottom cover and a lower cover for enclosing an accommodation space, the accommodation space being used for accommodating the release member; and
a positioning member, located in the accommodation space, and used for positioning the release member at different positions to move the dragging portion.

44. A stroller, comprising a wheel mechanism and a wheel steering mechanism for steering the wheel mechanism, wherein the wheel steering mechanism comprises:
a linkage member for steering a pair of wheel mechanisms of the stroller in linkage;
a crossbar for connecting two wheel seats of the stroller, the wheel seats being respectively pivotally connected to the wheel mechanisms; and
a holding device, arranged between the linkage member and the crossbar, and used for holding the pair of wheel mechanisms to be steered in linkage.
